(19) United States
(12) Patent Application Publication
(10) Pub. No.: US 2019/0263696 A1
(43) Pub. Date: Aug. 29, 2019

(54) APPARATUS AND METHOD FOR BIOFILM MANAGEMENT IN WATER SYSTEMS

(71) Applicants: Bernhard Wett, Innsbruck (AT); Sudhir N. Murthy, (US); Hampton Roads Sanitation District, Virginia Beach, VA (US); D.C. Water and Sewer Authority, Washington, DC (US)

(72) Inventors: Charles B. Bott, Virginia Beach, VA (US); Haydee De Clippeleir, Washington, DC (US); Bernhard Wett, Innsbruck (AT); Christine deBarbadillo, Washington, DC (US); Sudhir N. Murthy, Herndon, VA (US); Jessica Edwards-Brandt, Washington, DC (US)

(21) Appl. No.: 16/285,146

(22) Filed: Feb. 25, 2019

Related U.S. Application Data
(60) Provisional application No. 62/634,432, filed on Feb. 23, 2018.

(51) Int. Cl. C02F 9/00

(52) U.S. Cl. CPC C02F 9/00; C02F 3/34

(57) ABSTRACT

An apparatus and a method for removing constituents from an influent. The apparatus includes a biological processor that receives a water mixture as influent and outputs a liquor, a solid-liquid separator that receives the liquor and separates the liquor into a liquid and a solid; and a biofilm media that includes at least one media surface. The biofilm media may have a biofilm mass, biofilm volume, biofilm density, biofilm thickness, hydraulic retention time or solids residence time. The at least one media surface grows a biofilm that removes one or more constituents contained in the influent. The biofilm mass, biofilm volume, biofilm density, biofilm thickness, hydraulic retention time or solids residence time can be controlled by at least one of a physical process, a biological process or a chemical process.

### CROSS REFERENCE TO RELATED APPLICATION

This application claims priority to and the benefit of U.S. Provisional Patent Application No. 62/634,432, titled “Apparatus and Method for Biofilm Polishing in Water Systems,” filed Feb. 23, 2018, which is incorporated herein by reference in its entirety.

### FIELD OF THE DISCLOSURE

The disclosure relates generally to water, reuse and wastewater treatment and, more particularly, to removal of constituents from water in water systems.

### BACKGROUND

Biofilm systems have traditionally been used in wastewater treatment and more recently have received increased attention in reuse and drinking water systems. These biofilm systems have often been approaches where management of diffusion was of low priority with a greater focus being placed on providing support for organisms at a high enough solids retention time (SRT), and typically more SRT is better.

### SUMMARY OF THE DISCLOSURE

According to a non-limiting aspect of the disclosure, a technological solution is provided for removing constituents from water and providing an effluent having low turbidity and low pollutant residual. The technological solution includes a system, an apparatus and a methodology for treating water to achieve low turbidity, low chemical oxygen demand, low total organic carbon, or low pollutant residual. The technological solution includes an application of a reactant followed by a biofiltration system, among other things. The technological solution includes application of one or more chemical reactants (for example, oxidants or reactants) in combination with a biofilm system in water treatment.

According to a non-limiting example of the technological solution, an apparatus is provided for removing constituents from an influent. The apparatus comprises: a biological processor that receives a water mixture as influent and outputs a liquor; a solid-liquid separator that receives the liquor and separates the liquor into a liquid and a solid; and a biofilm media that includes at least one media surface, the biofilm media having a biofilm mass, biofilm volume, biofilm density, biofilm thickness, hydraulic retention time or solids residence time, wherein the at least one media surface grows a biofilm that removes one or more constituents contained in the influent, and wherein the biofilm mass, biofilm volume, biofilm density, biofilm thickness, hydraulic retention time or solids residence time is controlled by at least one of a physical process, a biological process or a chemical process.

The biological processor can comprise a bioreactor or a biofiltration system.

The biofilm media can have two or more media surfaces, each media surface having a different biofilm mass, biofilm volume, biofilm density, biofilm thickness, or solids residence time. At least one of the two or more media surfaces can be sheltered, partly sheltered, or unsheltered.

The biofilm media can include at least one of a ridge, a grid, a macro-pore inclusion, or a micro-pore inclusion on at least one of the two or more media surfaces or within the biofilm media.

The apparatus can comprise: a pretreator that applies a chemical agent such as ozone, chlorine, ultraviolet radiation, hydrogen peroxide, potassium permanganate or a biological agent to the influent or a recycle stream, wherein the chemical agent comprises a reactant, an oxidant, or a reductant, wherein the biological agent comprises a phage, a vector or a virus, and wherein the physical process or biological process comprises adding the chemical agent or the biological agent to the influent or recycle stream to control the biofilm mass, biofilm volume, biofilm density, biofilm thickness, or solids residence time. The chemical agent can include ozone, hydrogen peroxide, ultraviolet radiation, or potassium permanganate.

The apparatus can further comprise an augmentor that adds a nutrient or a cofactor to the influent or a recycle stream, wherein the nutrient comprises a trace element, nitrogen or phosphorous, wherein the cofactor comprises an organic coenzyme or an inorganic metal, and wherein the biofilm mass, biofilm volume, biofilm density, biofilm thickness, or solids residence time is controlled by the nutrient or cofactor. The inorganic metal can include iron, zinc, or copper.

The apparatus can further comprise a selector that applies the physical process by shearing the biofilm media to control the biofilm mass, biofilm volume, biofilm density, biofilm thickness, or solids residence time and also perform solids classification as needed.

The apparatus can further comprise a gas source that applies the physical process by scouring the biofilm media to control the biofilm mass, biofilm volume, biofilm density, biofilm thickness, or solids residence time.

The apparatus can further comprise a backwashing device that applies the physical process by backwashing the biofilm media to control the biofilm mass, biofilm volume, biofilm density, biofilm thickness, or solids residence time.

The constituents can comprise at least two of a micropollutant, a nanopollutant, a carbonaceous material, a nutrient, or an inorganic compound.

The biological processor can comprise a bioreactor and the biofilm media can comprise two or more carriers.

The apparatus can further comprise a controlled biofilm zone comprising a first carrier of the two or more carriers; and an uncontrolled biofilm zone comprising a second carrier of the two or more carriers, wherein a biofilm growing on the second carrier is sheared by the first carrier within the uncontrolled zone.

According to another non-limiting example of the technological solution, a method is provided for removing constituents from an influent, the method comprising: receiving a water mixture as influent; treating, by a biological processor, the influent to output a treated liquor; separating a solids mixture from the treated liquor; and controlling a biofilm mass, biofilm volume, biofilm density, biofilm thickness, or a solids residence time of a biofilm comprised in at least one media surface provided by a biofilm media to grow and remove one or more constituents contained in the influent, wherein the controlling the biofilm mass, biofilm volume, biofilm density, biofilm thickness, or the solids residence time comprises at least one of a: applying a physical treatment process; applying a biological treatment process; or applying a chemical treatment process.

In the method, the biofilm media can include at least one of a ridge, a grid, a macro -pore inclusion, or a micro-pore inclusion on the at least one media surface or within the biofilm media. The biofilm media can have two or more media surfaces, each media surface having a different biofilm mass, biofilm volume, biofilm density, biofilm thickness, or solids residence time. The method separating the solids mixture from the treated liquor can comprise applying a membrane, a filter, a clarifier or a hydrocyclone to the liquor.

In the method, the chemical treatment process can comprise adding a chemical agent or a biological agent to a recycle stream, wherein the chemical agent comprises a reactant, an oxidant, or a reductant, wherein the biological agent comprises a phage, a vector or a virus, and wherein the biofilm mass, biofilm volume, biofilm density, biofilm thickness, or solids residence time is controlled by the chemical agent or biological agent. The chemical agent can include ozone, chlorine, hydrogen peroxide, ultraviolet radiation, or potassium permanganate.

In the method, the biological treatment process can comprise adding a nutrient or a cofactor to a recycle stream, wherein the nutrient comprises a trace element, nitrogen or phosphorous, wherein the cofactor comprises an organic coenzyme or an inorganic metal, and wherein the biofilm mass, biofilm volume, biofilm density, biofilm thickness, or solids residence time is controlled by the nutrient or cofactor. The inorganic metal can include iron, zinc, or copper.

In the method, the physical treatment process can comprise applying a shearing force to the biofilm media by a solid-liquid separator to control the biofilm mass, biofilm volume, biofilm density, biofilm thickness, or solids residence time; scouring the biofilm media by a gas to control the biofilm mass, biofilm volume, biofilm density, biofilm thickness, or solids residence time; or backwashing the biofilm media to control the biofilm mass, biofilm volume, biofilm density, biofilm thickness, or solids residence time.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIGS. 1A and 1B illustrate examples of impacts of biofilm thickness on an effluent concentration of constituents such as carbonaceous material, readily biodegradable micropollutants and slowly biodegradable micropollutants, with FIG. 1A showing an impact by biomass limitation (or SRT) and FIG. 1B showing an impact by diffusion according to Fick's law of diffusion.

FIG. 2 illustrates an example of a relative balance that can be reached between SRT and biofilm thickness, with respect to removal of constituents such as total organic compounds (TOC) and readily and slowly biodegradable micropollutants.

FIGS. 3A and 3B illustrate examples of a response in terms of effluent quality (FIG. 3A) and removal rates (FIG. 3B) depending on biofilm thickness based on a sand filter example.

FIGS. 4A and 4B illustrate examples where an overall biomass thickness (FIG. 4A) or a biofilm composition (FIG. 4B) is controlled by using physical, chemical or biological control.

FIG. 5 shows an example of a carrier where a thin biofilm is maintained in combination with an uncontrolled thicker biofilm in protected zones.

FIG. 6 illustrates an example of a water treatment apparatus that is constructed according to the principles of the disclosure.

FIG. 7 illustrates another example of a water treatment apparatus that is constructed according to the principles of the disclosure.

FIG. 8 illustrates yet another example of a water treatment apparatus that is constructed according to the principles of the disclosure.

FIG. 9 illustrates a further example of a water treatment apparatus that is constructed according to the principles of the disclosure.

FIG. 10 illustrates a still further example of a water treatment apparatus that is constructed according to the principles of the disclosure.

FIG. 11 illustrates a still further example of a water treatment apparatus that is constructed according to the principles of the disclosure.

FIG. 12 illustrates a still further example of a water treatment apparatus that is constructed according to the principles of the disclosure.

FIG. 13 illustrates a still further example of a water treatment apparatus that is constructed according to the principles of the disclosure.

FIG. 14 illustrates a still further example of a water treatment apparatus that is constructed according to the principles of the disclosure.

FIG. 15 illustrates an example of effluent quality as a function of biofilm thickness.

FIG. 16 illustrates an example of effluent quality as a function of EBRT for different media types.

The present disclosure is further described in the detailed description that follows.

### DETAILED DESCRIPTION

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment may be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure may be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

Industrial, agricultural or residential practices can release a variety of constituents in water. The micropollutants can be harmful to animal health if not properly removed or disposed. The constituents can include, for example, organic contaminants, inorganic contaminants, micropollutants, nanopollutants, chemical compounds, pesticides, drugs, cleaning products, or industrial chemicals, which can be toxic to animal health, including human health. Some of the constituents can bioaccumulate in living organisms such as humans, resulting in serious harm to the organisms.

A biological treatment process can be used to remove constituents from water. The biological treatment process can be used in, for example, wastewater treatment, drinking water treatment, water reuse, distribution systems for drinking water, collection systems for wastewater, residential or institutional plumbing, natural or constructed wetlands, storm water treatment, agricultural buffers, or river bank filtration systems. Biological treatment can be carried out by microorganisms such as, for example, bacteria, mold, fungi, protozoa (for example, amoebae, flagellates, or ciliates), algae, metazoa (for example, rotifiers, namatodes, or tardigrades), or prokaryotes (for example, alphaproteobacteria, betaproteobacteria, gammaproteobacterial, bacteroidetes, or actinobacteria). The microorganisms can remove carbon or nutrient from the water by employing various metabolic or respiratory processes. Biodegradable organic material can be biochemically oxidized by, for example, heterotrophic bacteria under aerobic conditions, or under anaerobic conditions by, for example, methanogenic archaea.

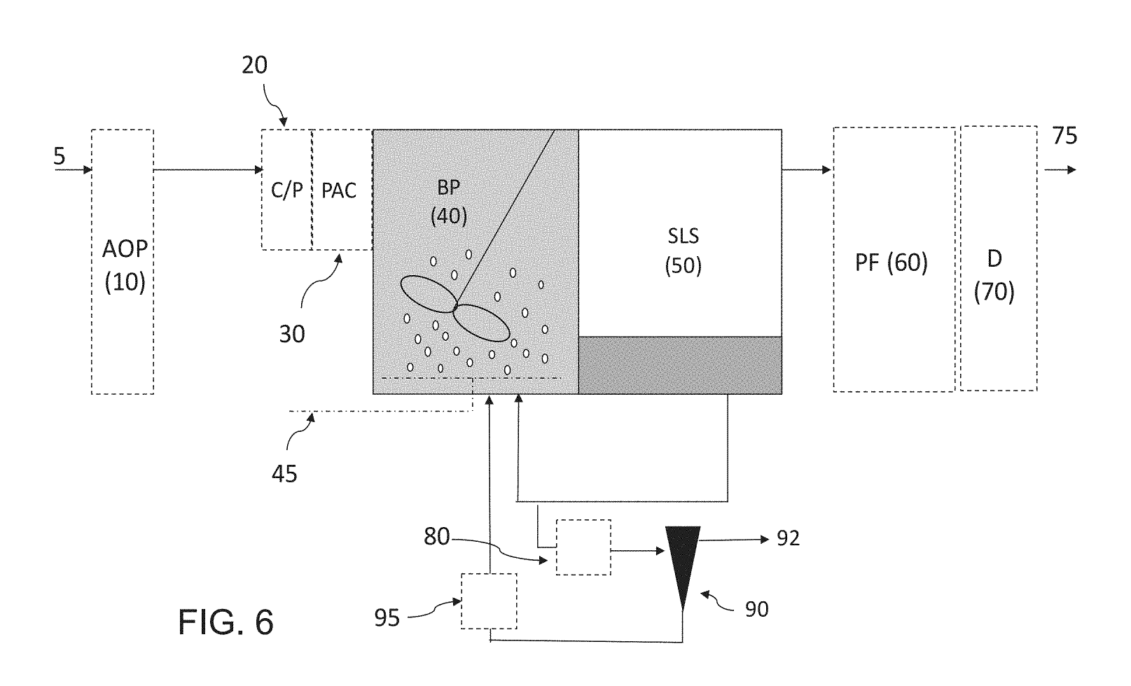

The technological solution can include a biofilm system, a water treatment apparatus or a water treatment process for removing constituents from water, including, for example, wastewater. The technological solution can include a biofilm system that facilitates or carries out biodegradation of constituents in a water treatment apparatus (such as, for example, a water treatment apparatus shown in any of FIGS. 6-14). The biofilm system can include a structured or unstructured community of microorganisms, which can be encapsulated within or attached to, for example, a self-developed polymeric matrix, and adherent to a living or inert surface or material. The biofilm system can include a monobiofilm or a plurobiofilm system. The monobiofilm consists of a single biofilm. The plurobiofilm system includes two or more biofilms that can be arranged in series, in parallel, or any combination of in series and in parallel, or in a tributary or a distributary configuration. The plurobiofilm can have two or more media surfaces carrying different biofilm masses, volumes, densities, thickness ranges, or solids residence times. The plurobiofilm can include a sheltered biofilm or an unsheltered biofilm. The plurobiofilm can include both sheltered and unsheltered biofilms. The plurobiofilm can include sheltered, partly sheltered or unsheltered surfaces to grow biofilms for the removal of constituents such as, for example, carbonaceous material, nutrients, organic compounds, inorganic compounds, micropollutants, or nanopollutants. The biofilm system can include a low diffusion biofilm. Diffusion can include transport that can result from random molecular motion and, at some point close to the microorganism cell level, diffusion can become critical for moving solutes toward or away from cell surfaces. Diffusion can be a dominant transport process within cell aggregates. The biofilm system can provide solids retention times (SRT) needed for degradation of constituents.

The technological solution can include a solid-liquid separator or a solid-liquid separation process that can be combined with a biological processor or a biological treatment process. The solid-liquid separator or processor can manage concentration of constituents or turbidity in the effluent output from the technological solution. Since the growth function of biofilms to degrade constituents (such as, for example, complex substrates or pollutants) can run counter to solid-liquid separation in water treatment systems or processes, the technological solution provides a mechanism for optimizing biofilm growth and solid-liquid separation to provide an effluent that can meet or exceed water purity requirements for human consumption, or for discharge into the environment, such as, for example, in a stream, a river, a wetland, or an ocean. Additionally, there are influent characteristics that could result in constituents being degraded at different rates. The biofilm system and process in the technological solution can include a plurobiolm having multiple (for example, two or more) biofilm surfaces to degrade constituents with different degradability rates and to support microorganisms needing different SRTs, thereby providing a comprehensive solution for, not only managing biofilm thicknesses (or the underlying diffusion or their relative SRT management), but also the solid-liquid separation process. The technological solution provides a comprehensive solution for achieving low turbidity and low pollutant residual in effluent. The technological solution can provide an effluent having, for example, a turbidity level of 0.05 nephelometric turbidity units (NTU) or less, and in the influent, a color of about 20 to 60 mgPt/L (in Platinum Cobalt Units on the Hazen Scale), and a TOC of about 0.2 to 10 mg/L. The technological solution can achieve residual levels or concentrations of constituents in the effluent safe for human consumption or for discharge into the environment. Turbidity can be measured using, for example, a turbidimeter.

The technological solution can include, among other things, a step of applying a reactant, such a, for example, a chemical, followed by a biofilm media or floc system contained in a membrane reactor, or the application of a reactant, such as, for example, a chemical like chlorine or a gas such as ozone, followed by a biofilm system. The technological solution can include a roughing media to degrade a readily degradable organic material that is made labile by the reactant, followed by a downstream media that can be used to degrade more refractory substrates. The two media can remove turbidity associated with the solid-liquid separation function.

The biofilm system includes biofilms that facilitate degradation in constituents such as, for example, total organic compounds (TOC), micropollutants or nanopollutants. The biofilm system can effectively and efficiently remove constituents from water. The technological solution can manage and control effluent properties such as, for example, turbidity, pH level, or constituent concentration levels. The technological solution can manage and control film thickness(es) or biomass(es) in a manner that can provide exceptional effluent quality without a treatment system or process becoming biomass (SRT) limiting or turbidity limiting. For instance, the technological solution can be used in treating wastewater to output a final effluent that meets or exceeds quality standards for human consumption or for discharge in the environment.

As noted above, the biofilm system can include a monobiofilm or a plurobiofilm having two or more media surfaces for growing different (or the same) types of biomasses. The plurobiofilm can include sheltered, partly sheltered or unsheltered biofilms. The biofilm(s) can be controlled or uncontrolled. The biofilm(s) can be thin or thick, or tailored for specific degradation of constituents or to otherwise support slowly or more readily growing organisms. The technological solution can manage and control turbidity or a solid-liquid separation process that can be decoupled from the biofilm management process.

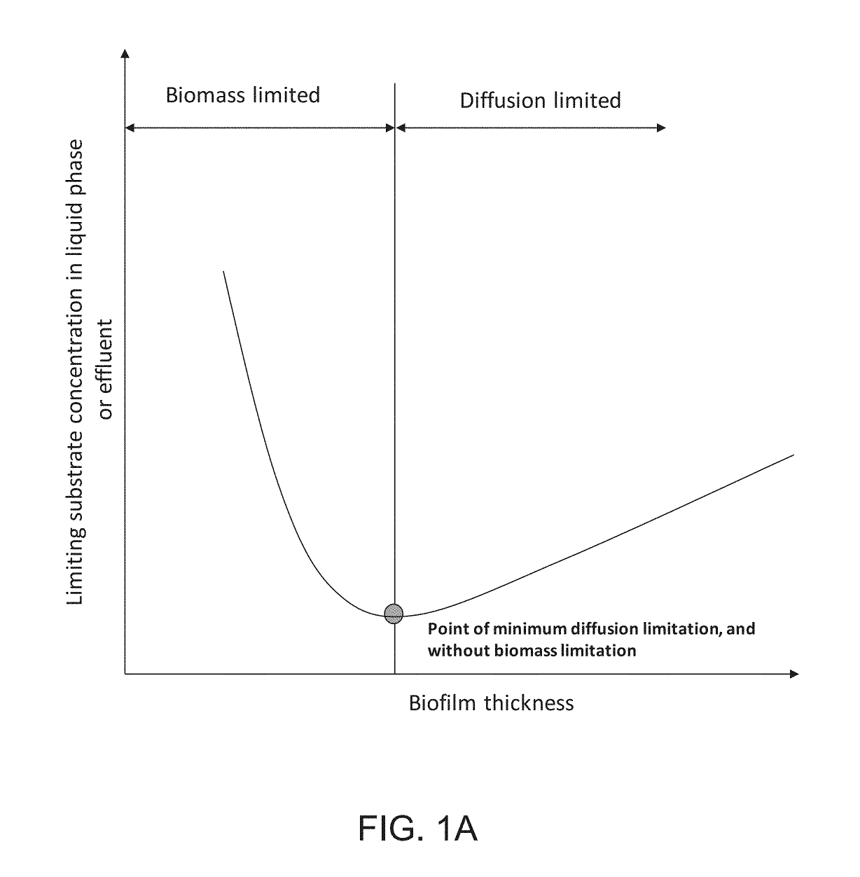

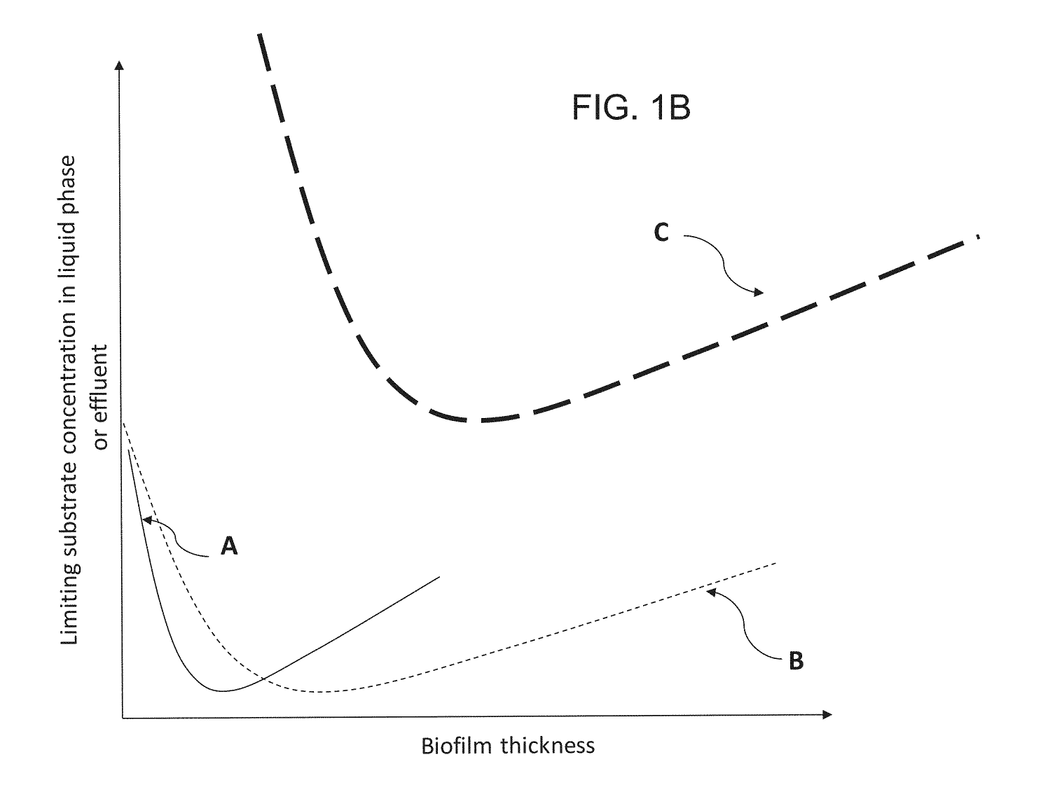

FIGS. 1A and 1B illustrate examples of an impact of a biofilm thickness on an effluent concentration of a constituent having a carbonaceous material, a readily biodegradable micropollutant and a slowly biodegradable micropollutant. The constituent having a carbonaceous material can include, for example, total organic compounds (TOC) or total organic substrate (TOS). As seen in FIG. 1A, the constituent concentration in an effluent can vary in two regions, a biomass (or SRT) limited region and a diffusion limited region. In the biomass limited region, the constituent concentration can be limited effectively with increasing thickness of a biofilm in the biofilm system until a point of minimum diffusion limitation is reached. The minimum point can be without biomass limitation. The minimum point can correspond to the minimum point in the diffusion limited region. Before reaching the minimum point, the limiting effect of the biofilm thickness on the constituent concentration can be substantially linear for a range of biofilm thicknesses and then level off before transitioning to the diffusion limited region and changing directions, with the constituent concentration increasing with increasing thickness of the biofilm. The constituent concentration can increase linearly with increasing biofilm thickness in the diffusion limited region.

FIG. 1B shows examples of an impact of biofilm thickness on three different types of biodegradable constituents. The curves A, B, and C depict the effect of biofilm thickness on the limiting of constituent concentration of readily biodegradable constituents (curve A), slowly biodegradable constituents (curve B), and total organic compounds (TOC) micropollutants (curve C) in the effluent, respectively.

As seen in FIG. 1B, the three curves A, B, C have minimum constituent concentrations at different biofilm thicknesses. As demonstrated by the curve A, readily biodegradable constituents may need very thin biofilms, since they are not too limited by biomass. Such thin biofilms may need to be more actively managed. On the other hand, slow degrading constituents are more likely to be biomass limited and will need longer SRTs. The organism maximum specific growth rates can vary from, for example, about four to five days for fast growing organisms, to about one day for aerobic autotrophic organisms and slower growing organisms, and to about one-tenth of a day (or about 2.5 hours) or less for very slow growing organisms. The first order growth rates can be lower depending on the position of the organisms in a substrate limited biofilm. Minimum SRT requirements correspond to these maximum growth rates and are typical a reciprocal of these rates. A low SRT can be about two to three days, or, in some instances, less than a day. A moderate SRT can be about five to ten days, or more. A high SRT can be greater than ten days, such as, for example, twenty to thirty days, and, in some instances, as long as one hundred days, or more. Managing these multiple constituents is complex with a single biofilm or multiple biofilms of a single type of biofilm (for example, same or similar thickness, or same or similar microorganism). However, the biofilm system in the technological solution, where degradation of each constituent can be optimized within two or more biofilms within controlled or uncontrolled biofilms, within thin or thick biofilms, or within sheltered or unsheltered biofilms, can optimize management of these multiple constituent simultaneously in a water treatment apparatus or process. A sheltered biofilm can include a shelter such as biofilm matrix or other physical structure that can shelter bacterial cells from antimicrobial agents or environmental stress by acting as a physical barrier. The physical structure can include, for example, a ridge, a grid, or a matrix, or a macro-pore or a micro-pore inclusion on a media surface or within a media. The media can include a material or substrate that can support and foster growth of an organism.

In the biofilm system, the biofilm thicknesses can range anywhere from, for example, about 5 μm (or less) to about 50 μm for a thin biofilm, and from about 50 μm (or less) to about 500 μm for a thick biofilm. The biofilm, along its thickness, can include anywhere from, for example, five (or fewer) numbers of microorganisms (end-to-end) to fifty (or more) microorganisms. Each biofilm thickness should be such that it can be actively managed to minimize turbidity or constituents in the effluent. Readily biodegradable constituents tend not to be too limited by biomass, as seen in the curve A in FIG. 1B. When biomass limitation is overcome by sufficient retention, thicker biofilms can increase constituent concentrations due to the impact of diffusion limitation within the biofilm. This can be especially the case if a biofilm is grown on a macro-substrate that is present at much higher concentrations than the constituent. An optimal point at which biomass limitation and diffusion limitation are balanced can be reached, as seen, for example, in FIG. 1A—particularly when using multiple biofilms. On the other hand, slow degrading constituents are more likely to be biomass limited and will need a longer SRT, as seen in curve B (shown in FIG. 1B). The biofilm system in the technological solution can optimize each constituent within two or more biofilms in the plurofilm. As noted above, the biofilms can include a controlled or uncontrolled biofilm, a thin or thick biofilm, or a sheltered or unsheltered biofilm. It is noted that the thickness of a thin biofilm can be just a few μm or less in thickness, and a thick film can be 50 μm or more.

According to a non-limiting example of the disclosure, a biofilm can be grown in a shelter or an inclusion such that the biofilm can self-regulate its biomass and biofilm thickness. This self-regulation can address temperature changes or mass loading changes. The self-regulated biofilm can have a higher SRT compared to a non-self-regulated biofilm. The higher SRT can facilitate growing or degrading a difficult to degrade constituent in a shelter, such as, for example, an unrestricted self-regulated SRT shelter. A substrate, a micronutrient or a co-substrate provision can be included in or applied to the biofilm, or provided through an annulus of a porous biofilm support to facilitate growth. The self-regulated or sheltered biofilm can have more diffusion resistance than an unsheltered, actively managed biofilm that can be used to degrade readily degradable constituents, or constituents that have a larger mass or concentration. This can allow for microorganisms that use readily or more easily degradable carbons or substrates to preferentially coexist in low diffusion conditions, since microorganisms will prefer to locate in conditions of low diffusion to access substrates more easily. The more difficult to degrade constituents can be degraded or grown on a slightly more diffusion resistant biofilm. The thickness of the more diffusion resistant biofilm can depend on the thickness of the more actively managed biofilm.

The thicknesses of the biofilms can be managed in series or in parallel, or any combination of in series or in parallel, or in a tributary or distributary configuration. For example, an actively managed biofilm can be a roughing biofilm that precedes a sheltered biofilm that is passively managed. In one example, an actively managed biofilm can consist of anthracite or expanded clay on top of a granular activated carbon (GAC) that consists of shelters. The anthracite or expanded clay can be actively scoured or backwashed to manage biofilm thickness and SRT, while the GAC can support the degradation of constituents. The actively managed biofilm can be used to control effluent solids and turbidity through scouring or one or more backwash cycles. The vice-versa can also take place, depending on the application of the technological solution.

In a non-limiting example of the technological solution, a monofilm can be included in a depth or a length of a reactor (for example, a bioreactor 40 shown in FIG. 6), the biofilm thickness can be regulated by an SRT management process. The SRT management process can include wasting, backwashing or air scouring, as provided for in the water treatment apparatus shown in FIGS. 6-14. For unregulated or self-regulated (uncontrolled) biofilm, the biofilm thickness can be dependent on the mass of biofilm needed to maintain a minimum bulk effluent constituent concentration, which can be approximately a half saturation coefficient (Kₛ) of the biofilm for an industry-acceptable hydraulic retention time (HRT) water treatment apparatus. As the constituent concentration goes lower than Kₛ, the rates decrease to an extent that the size of the reactor (such as, for example, bioreactor 40 shown in FIG. 6) that is needed becomes unreasonably large. Thus, the point of minimum diffusion limitation in FIGS. 1A, 1B is approximately the Kₛ for self-regulated biofilms.

The Kₛ can be lowered by making the biofilm thinner. This can be achieved by, for example, increasing a surface area for a biofilm to grow, thereby allowing the biomass to spread out over a larger surface area. This can also be achieved by a plurobiofilm that includes two or more biofilms in the biofilm system, including a thin unsheltered biofilm with a managed SRT for the faster degrading substrates, and a slightly thicker sheltered biofilm to grow the longer SRT needing substrate. According to a non-limiting example of the biofilms system, the thinner unsheltered biofilm can have a thickness of about 5 μm (or less) to about 50 μm (or less), and the thicker sheltered biofilm can have a thickness of about 10 μm to about 500 μm. These two approaches can provide for a decrease in Kₛ and a decrease in the self-regulated biofilm thickness and effluent concentration. The Kₛ can be, for example, about 10 μg/L to about 100 μg/L for constituents.

According to a non-limiting example of the disclosure, the biofilm system can be included in a wastewater treatment process to remove constituents from influent wastewater. In wastewater treatment processes, an increase in constituent concentrations in effluent from summer to winter can occur due to an increase in thickness of a biofilm, which can result in an increase in diffusion resistance and an increase in Kₛ and thus a movement of the minimum point, as seen in FIG. 1B. The minimum point in Curve B will have a higher concentration than Curve A, because the biofilm is thicker. In applications of the technological solution, such as, for example, in reuse or drinking water biofiltration (such as, for example a biological activated carbon (BAC) reactor), the biofilm thickness can range from about 1 μm to about 50 μm, and as much as 500 μm. In BAC reactors, the empty bed contact time (EBCT) can be from about 5 minutes to about 20 minutes, and sometimes 30 minutes or more (for example, as much as 60-90 minutes) for reuse systems. In general, the EBCT can range from about 2 to 4 minutes for readily degradable constituents, about 5 to 30 minutes for slowly degradable constituents, and as much as 60 minutes, or more, in reuse applications. The EBCT can differ by a factor of 5 to 10 times between the EBCT for readily and slowly degradable constituents. Hydraulic loading rates can range from about 1 m/h to about 10 m/h or as high as 15-20 m/h, or more for some systems. Higher loading rates can create thicker biofilms and vice versa.

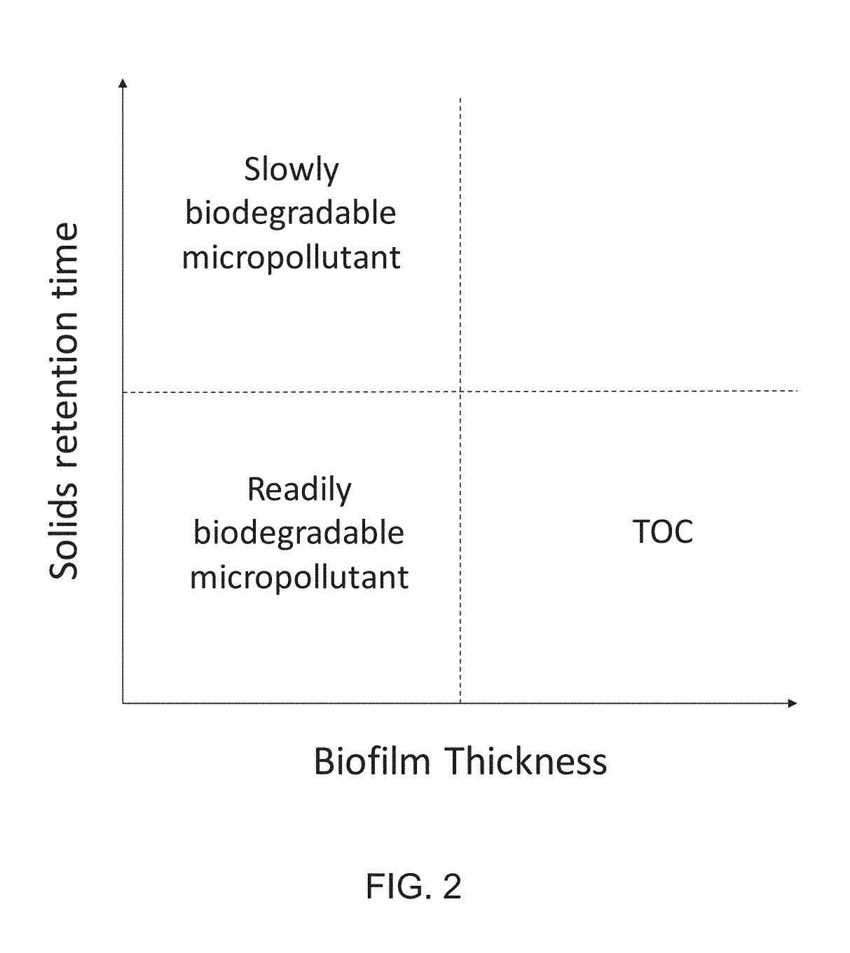

FIG. 2 illustrates an example of a balance that can be reached between SRT and biofilm thickness with respect to removal of constituents such as, for example, total organic compounds (TOC) and readily and slowly biodegradable micropollutants. A thinner biofilm can be included to achieve removal of constituents that may be present at low concentrations and overcome diffusion limitation. When, for example, a TOC is to be removed at the same time as a micropollutant, such as, for example, where a multifold difference in concentration exists, multiple biofilms thicknesses can result. The thickness of the biofilm associated with TOC can drive the overall thickness in a monobiofim. To address this, the biofilm associated with TOC can be grown at a lower SRT by, for example, backwashing, air scour, or other physical, chemical or biological treatment process to manage or control a biofilm mass, biofilm volume, biofilm density, biofilm thickness, or a solids residence time of the biofilm. Growing the biofilm associated with TOC or labile pollutants from oxidation or AOP reaction (for example, with ozone, hydrogen peroxide, or Ultraviolet radiation) at a lower SRT can aggressively remove grown biofilm, thus maintaining a thin biofilm. An unsheltered biofilm will need and have lower diffusion resistance than a sheltered biofilm carrying specialized microorganisms. So, if the higher SRT sheltered biofilm needs to be thin to decrease the bulk concentration of a constituent, the unsheltered biofilm needs to be thinner, or alternatively, the readily degradable constituent in the unsheltered biofilm needs to be exposed to a shorter hydraulic residence time (HRT), or alternatively it needs to precede the sheltered biofilm or a series, tributary or distributary biofilm for degrading constituents. For a series, tributary, or distributary biofilm, the biofilm can be either sheltered or unsheltered.

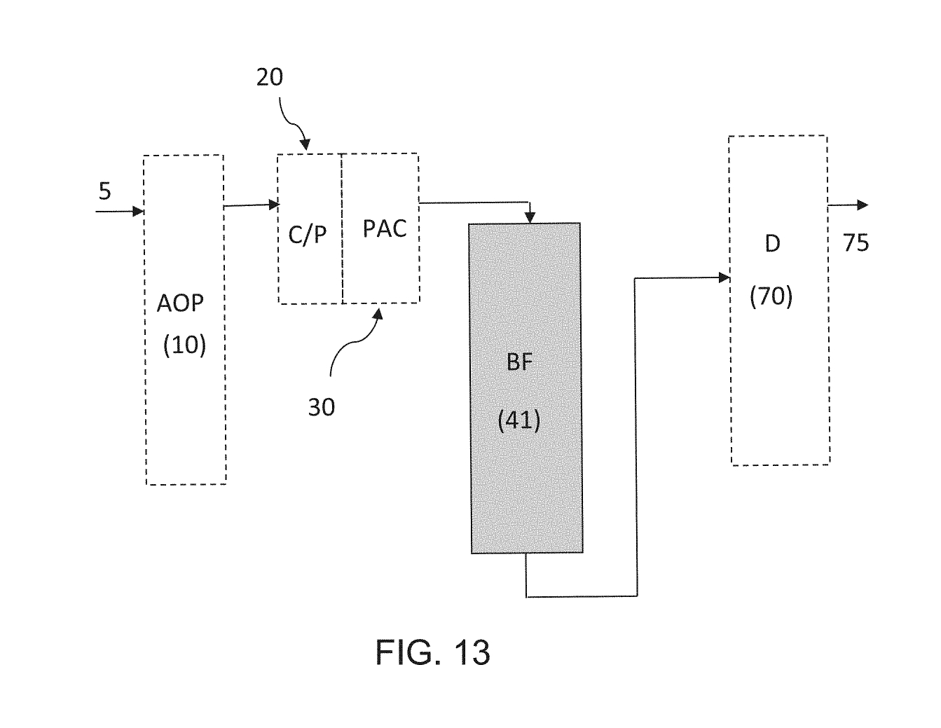

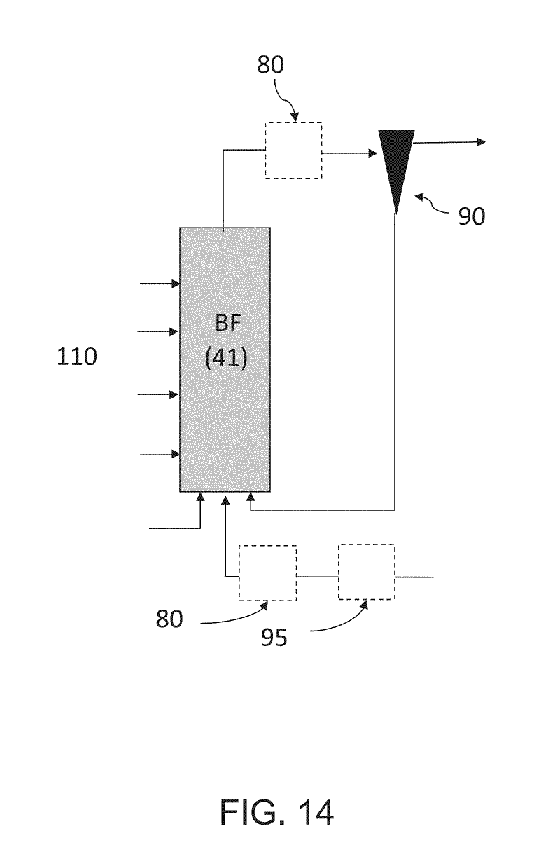

It is noted that in this specification, wherever a description is provided in terms of thickness associated with a biofilm, the term applies equally to a biofilm mass, biofilm volume, or a biofilm density, but the dimensions of mass, volume or density will need to be appropriately proportioned, as understood by those skilled in the pertinent art. Any implementation of a biofilm can include arrangements of two or more biofilms arranged in series, in parallel, in tributary (for example, where additional flows such as a bioaugmentation, co-substrate, or micronutrient are added to a downstream reactor) or in distributary (for example, where flow from one reactor is distributed into two or multiple parallel reactors) configurations. A distributary configuration can be particularly beneficial where a small roughing reactor is used to degrade easy to degrade but high mass pollutants followed by either a larger reactor or multiple downstream reactors. The reactors can precede a solid-liquid separator (SLS), which can include a device or a process. Instead of reactors, one or more filters (such as, for example, BF 41 shown in FIG. 13 or 14) can be implemented. The SLS can include a membrane, a lamella, a clarifier, a solids contact clarifier, a dissolved air flotation device, or a filter, which can include a ceramic filter, a disc filter, a fabric disc filter or a mesh disc filter.

The reactor (or filter) can be preceded by either a chemical oxidation step or device, a chemical reduction step or device, a rapid mix or flocculation step or device that adds a coagulant or a flocculant, a mixing step or device that adds or mixes in a biofilm support media (such as, for example, powdered activated carbon, granular activated carbon, or any material with reactive properties), a mixing step or device that adds or mixes in a biofilm support media for biofilm attachment, a mixing step or device that adds or mixes in a biofilm support media for biofilm ballasting, a pre-settling step or device, or an equalization step or device. These preceding steps or devices can be configured as a single process or device, or multiple processes or devices. Depending on the biodegradability of a constituent, a differentiation in solids retention times might be needed while maintaining the thin biofilm to support a bulk effluent constituent concentration. The graph in FIG. 2 illustrates an advantage of including a plurobiofilm that includes multiple biofilm thicknesses and multiple solids retention times within one biofilm system. The graph shows a basis for multiple biofilm thicknesses, as well as in series, in parallel, distributary or tributary configurations, and multiple solids retention times (SRTs), hydraulic retention times (HRTs) or hydraulic loading rates (HLRs) that can be included in the biofilm system.

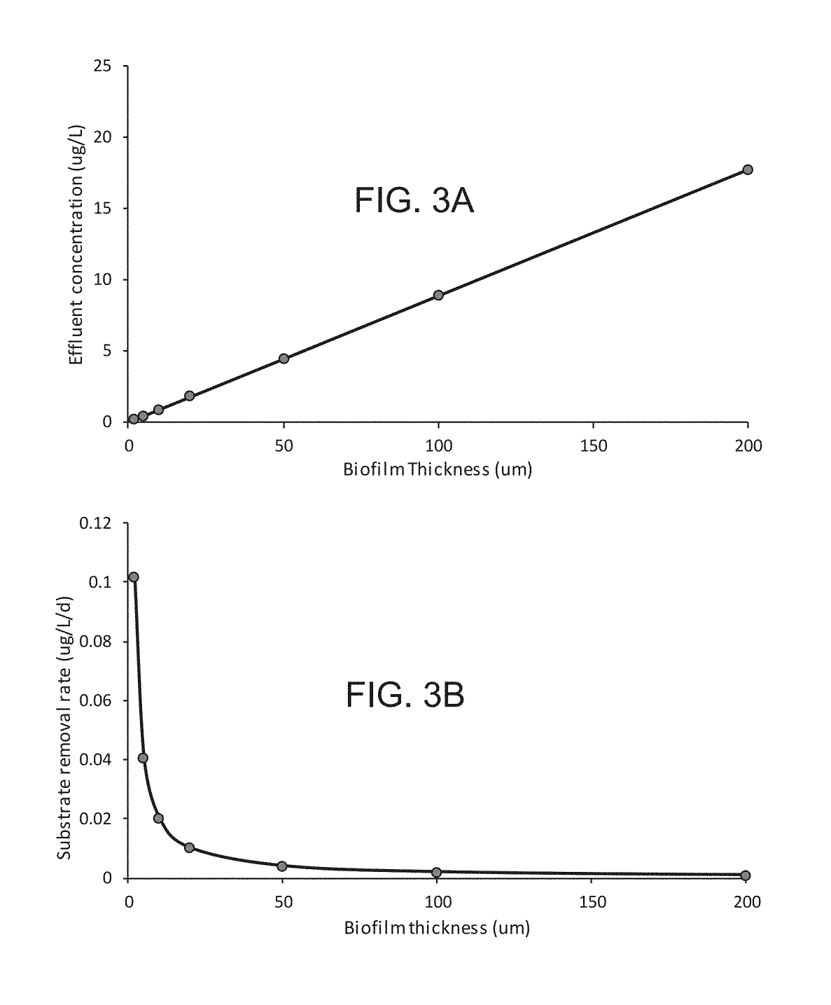

FIG. 3A illustrates an example of a constituent concentration in effluent (in μg/L) as a function of biofilm thickness (in μm), and FIG. 3B illustrates an example of constituent removal rate (in μg/L/d) as a function biofilm thickness (in μm). The graphs are based on a sand filter example. As seen in FIG. 3A, the constituent concentration can vary linearly as a function of the biofilm thickness. In this example, the constituent concentration can increase proportionately from about 0 μg/L to about 18 μg/L with a corresponding increase in biofilm thickness ranging from about 1 μm (or less) to about 200 μm. Meanwhile, the constituent removal rate drops non-linearly from about 0.1 μg/L/d to about 0 μg/L/d as biofilm thickness increases from about 1 μm (or less) to about 200 μm. As seen in FIG. 3B, the rate of change in the constituent removal rate can vary exponentially as a function of the biofilm thickness, with the greatest change in rate occurring for a biofilm thickness between about 1 μm (or less) to about 50 μm.

As seen in FIGS. 3A and 3B, a 10 μm biofilm can support a bulk constituent concentration (in the effluent) of about 1 μm/L or higher (for example, as high as 10 μm/L), depending on the empty bed contact time (EBCT), HRT, hydraulic loading rate, molecule size or biofilm density. A 100 μm biofilm can support a bulk constituent concentration of as low as about 10 μg/L (or lower) or as high as 100 μg/L (or higher), depending on the same foregoing factors. These are broad range representations of bulk concentrations, and other values are possible and contemplated in this disclosure. Approaches using surface chemistry of sorption (within say an activated carbon pore or surface), extracellular polymeric substance associated substrate entrapment, ion exchange, capillary or surface tension forces, or any other substrate attraction approach can increase the bulk constituent concentration compared to the effluent. This increase can subsequently increase substrate reaction rates associated with its removal thus decreasing the final constituent concentration.

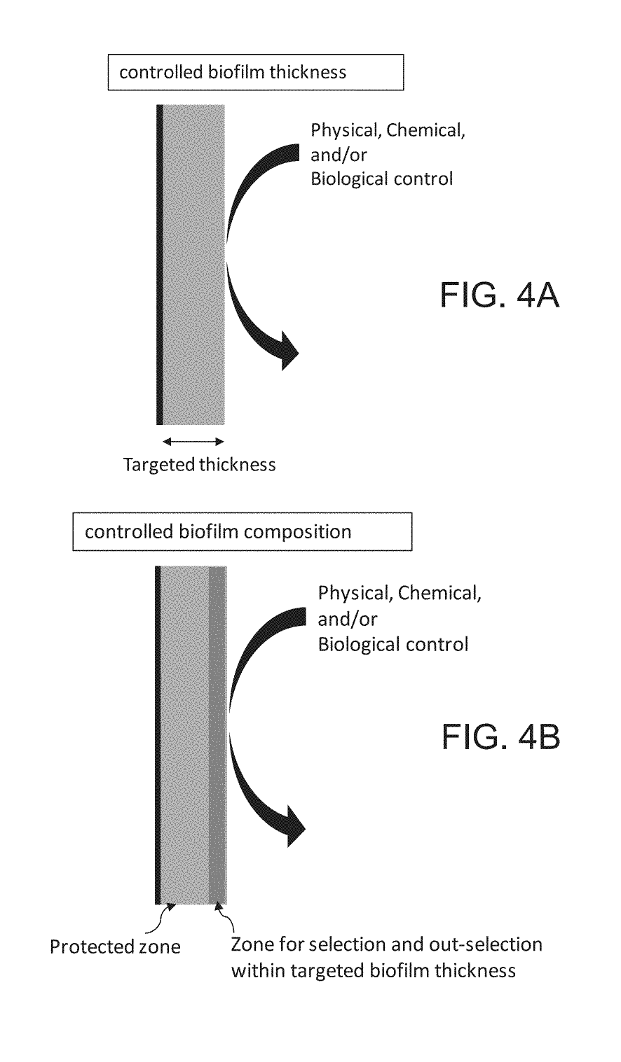

FIGS. 4A and 4B illustrate examples where an overall biomass thickness (FIG. 4A) or a biofilm composition (FIG. 4B) is controlled by applying a physical, chemical or biological control. In FIG. 4A, an overall biofilm thickness and a substrate removal is targeted, with physical, chemical, or biological control to form a controlled area. FIG. 4B shows an example of a biofilm composition having a protected zone and a selection zone being implemented with physical, chemical, or biological control to form the controlled area. The selection zone can be formed in an outer layer of the biofilm to create the protected zone for enrichment and growth of organisms. The organisms can include anoxic or anaerobic organisms. The protected zone can promote enrichment and growth of the organisms, while aerobic organisms or organisms that need longer solids retention times can occur in the controlled area.

A device such as a hydrocyclone or an air scouring device, or other approaches to scour or shear the biofilm can be used to physically manage thickness. Exposure of biofilms to a microbe specific toxicant, inhibitor, co-substrate (especially to degrade a refractory pollutant), enzymes, cofactors or other nutrients can also be used to chemically control the biofilm. Biological control can be used in the form of microbe specific phage or biological vector, or bioaugmented organisms for biofilm thickness and composition control. Analyzers or other instrumentation (manually or on-line) can be used to monitor or control the biofilm mass, volume, density or thickness, directly or indirectly. For instance, the effluent can be monitored and constituent concentration measured and, based on measurement results, shearing or scouring of the biofilm(s) can be controlled to adjust the constituent concentration in the effluent to predetermined values. Surrogates for biofilm thickness, mass, volume or activity measurement, such as, for example, using adenosine triphosphate (ATP), respirometry, optics or acoustics, can also be used.

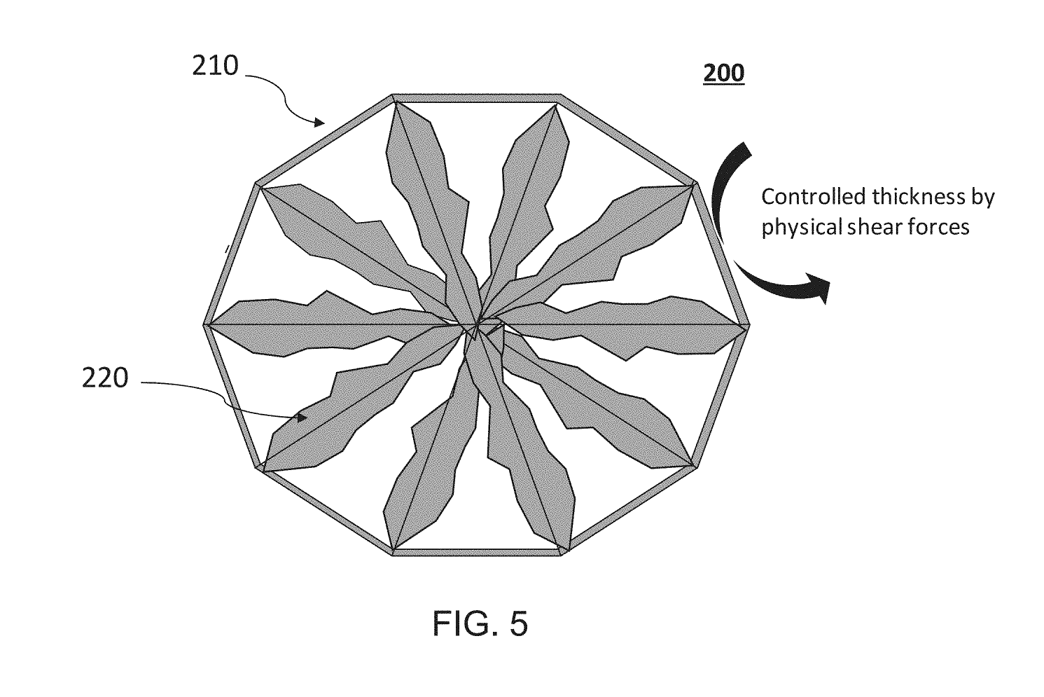

FIG. 5 shows an example of a carrier 200 having a biofilm system constructed according to the principles of the disclosure. The carrier 200 can include plurobiofilm that has a combination of a thin biofilm and a thick biofilm. For instance, the carrier 200 can include a carrier portion 210 having a thin biofilm with a controlled biofilm thickness and a carrier portion 220 having a thicker biofilm with an uncontrolled biofilm thickness in protected zones of the carrier 200. The carrier portion 210 can include a biofilm thickness that can be controlled by physical shear forces applied to an outer shell of the carrier 200. The thin biofilm can be, for example, maintained by increased shear forces on the outer shell of the carrier 200. The thickness of the biofilm in the carrier portion 220 (for example, in the protected zones) can be greater than the thickness of the biofilm in the carrier portion 210. The biofilm system having multiple biofilms can include two or more distinct carrier types to allow for different surface areas and different protected versus non-protected zones on the carriers. When the biofilm system has a combination of different carriers mixed in, for example, reactor vessels or filters, increased abrasion on the smaller carrier(s) can be achieved to maintain a thin biofilm. The biofilm system can include, for example, a textile formed around a membrane to decrease biofouling of the membrane. Abrasion of a membrane through a carrier (such as, for example, carrier 200), or other media (not shown) that can scour the membrane, can be an added benefit. The desired biofilm mass ratio can be adjusted by developing de novo carrier design features to meet specific influent water characteristics, biofilm yields or SRTs needed for each controlled or uncontrolled fractions.

FIG. 6 shows an example of a water treatment apparatus that is constructed according to the principles of the disclosure. The apparatus can receive wastewater 5 as an influent and output a clean effluent 75 and a waste 92. The apparatus includes a biological processor (BP) 40 and a solid-liquid separator (SLS) 50. The apparatus can include an advanced oxidation processor (AOP) 10, a coagulator (C/P) 20, or a secondary coagulator (PAC) 30. The AOP 10, C/P 20, or PAC 30 can be located upstream of the BP 40, as seen in FIG. 6. The BP 40 can include a biofilm system (for example, carrier 200 shown in FIG. 5). The biofilm system can include a monobiofilm media or a plurobiofilm media that can be located in series, in parallel, in a tributary, or in a distributary arrangement. The wastewater 5 influent can be supplied to the AOP 10, C/P 20, PAC 30, or BP 40 directly.

The apparatus can include a post-filtration device (PF) 60 or a disinfector (D) 70. The PF 60 or D 70 can be located downstream of the SLS 50, as seen in FIG. 6. The effluent 75 can be output from the SLS 50, PF 60, or D 70 directly. The waste 92 can be output from the SLS 50, PF 60, or D70 directly.

The apparatus can include a pretreator 80, a selector 90, or an augmentor 95. An input of the pretreator 80 can be connected to an output of the SLS 50. The pretreator 80 can be configured to receive gravity-selected constituents from the SLS 50 at its input and apply a chemical, biological or physical treatment process on the input constituents to output pretreated constituents at an output. The output can be connected to an input of the selector 90. The

The selector 90 can be configured to receive the pretreated constituents at its input and separate constituents based on, for example, density or size. The selector 90 can include the gravimetric selector 11 in U.S. Pat. No. 9,242,882, titled “Method and Apparatus for Wastewater Treatment Using Gravimetric Selection,” or the gravimetric selector 260 in U.S. Pat. No. 9,670,083, with disclosures in both patents being incorporated herein in their entireties by reference. The selector 90 can select larger or denser constituents from smaller or less-dense constituents and output the larger or denser constituents at a first output to the augmentor 95 (or directly to the BP 40) and the smaller or less-dense constituents at a second output as waste 92.

An input of the augmentor 95 can be connected to the first output of the selector 90, and an output can be connected to the BP 40. The augmentor 95 can be configured to apply bioaugmentation, nutrients, or cofactors to the received constituents before outputting augmented constituents at an output to be supplied to the BP 40.

The AOP 10 can include a device that implements an oxidation or reduction method, including, for example, an aqueous phase oxidation method. The method can consist of a highly reactive component that can be used in the oxidative destruction of target pollutants. The reactive component can include, for example, ozone (O₃), ultra-violet (UV), or hydrogen peroxide. The component can be applied to the influent wastewater 5 to destroy target pollutants and output a liquid flow having reduced pollutants.

The C/P 20 can include a device that implements a coagulation or flocculation method. The C/P 20 can include a device that can introduce natural or synthetic water-soluble compounds to, for example, a liquid flow input from the AOP 10. The compounds can include one or more polymers, such as, for example, macromolecular compounds that have the ability to destabilize or enhance coagulation or flocculation of the constituents in the liquid flow. The compounds can be included in solid or liquid form.

The PAC 30 can include a device that includes a coagulation method, including, for example, a device that adds a poly-aluminum chloride-based coagulant or other coagulant that has, for example, low generation of waste sludge in a wide pH range, event at varying temperatures (for example, at low temperatures). The PAC 30 can include a device that includes a filtration method. The PAC 30 can include, for example, powdered activated carbon (PAC) media or a granular activated carbon (GAC) medium.

The BP 40 can include a reactor, a bioreactor, or a plurality of reactors or bioreactors. The reactor can include a tank or a vessel. The bioreactor can include a biological treatment tank that can receive influent and contain a biological treatment process. The biological treatment process can include an aerobic biological treatment process or an anaerobic treatment process that can treat organic constituents in the influent. As seen in FIG. 6, the BP 40 can include a gas source 45. The gas source 45 can include one or more nozzles (not shown) that can inject a gas such as, for example, air or oxygen (O₂) into the tank. The gas source 45 can include one or more pipes to supply the gas to tank or the nozzle(s). The gas can promote an aerobic biological treatment process in the tank.

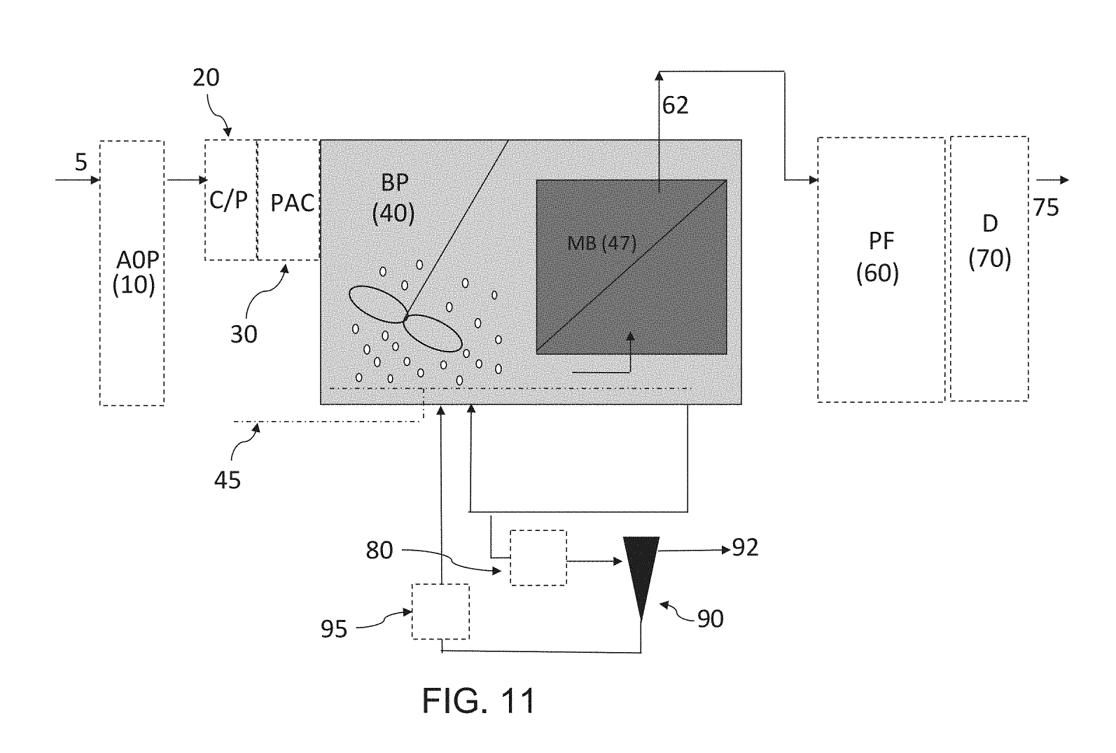

The SLS 50 can include a clarifier, a settling tank, a cyclone, a centrifuge, a membrane, disc filter, or any other device or process that can separate solids from liquid. In the example seen in FIG. 6, the SLS 50 includes a settling tank. The SLS 50 can include an MB 47 (shown in FIG. 11).

The PF 60 can include a post-filtration device that includes a sand filter, granular activated carbon (GAC), powder activated carbon (PAC), biological-activated carbon (BAC) or any other mechanism for biological degradation or adsorption of constituents.

The D 70 can include a device that disinfects an influent. The device can include a device that applies a gas or radiant energy to the influent. The radiant energy can include, for example, energy having a frequency in the ultraviolet (UV) range of the spectrum. The gas can include, for example, ozone (O₃).

The pretreator 80 can include a device that applies chemical pretreatment such as, for example, chemical coagulation. The pretreator 80 can include sedimentation unit (not shown), which can follow coagulation to sediment and remove of flocs or coagulants.

The pretreater 80 can include a device that applies biological pretreatment, such as, for example, adding a flocculent to maximize flocculent dispersion. The flocculant can include a polymer.

The pretreator 80 can include a device that applies physical pretreatment, such as, for example, a screen (not shown), a membrane (not shown), a clarifier (not shown), a cyclone (not shown), a centrifuge (not shown), or any other device or methodology that can separate solids from liquid or from other solids, or that can shear a biofilm from the support media. The pretreator 80 can include oxidation, nanofiltration, reverse osmosis filtration, or activated carbon filtration.

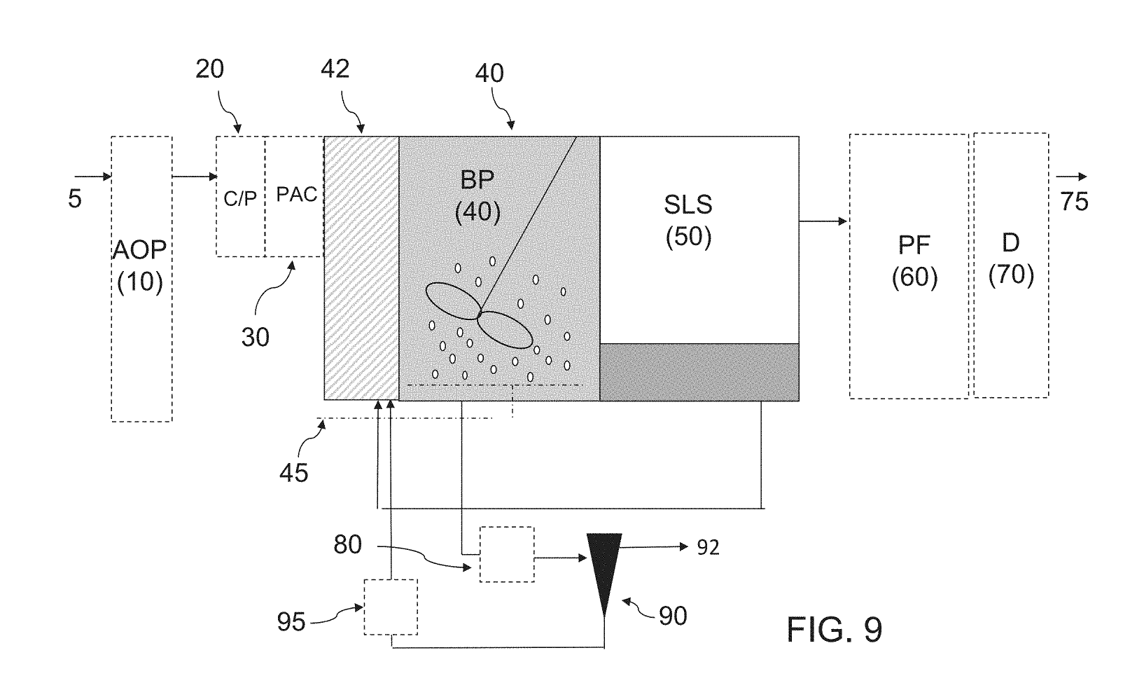

The selector 90 can include physical selector device such as, for example, a settling tank, a cyclone, a centrifuge, or any other device or process that can separate solids from liquid. In the example seen in FIG. 6, the selector 90 includes a hydrocyclone. The selector 90 can include a single device or a plurality of devices arranged in series, in parallel, or any combination of in series or in parallel. For example, the selector 90 can include a hydrocyclone manifold having two or more hydrocyclones that can be selectively placed in-line via one or more valves (not shown), depending on need, to control the rate or volume of the recycle stream that can be supplied to the BP 40 or UBZ 42 (shown in FIG. 9) or BF 41 (shown in FIG. 14) to manage and control shearing of the biofilm(s) in the apparatus. The hydrocyclones can be configured in series, in parallel, or any combination of in series or in parallel. The hydrocyclones can include fixed-flow hydrocyclones, in which case flow rate can be controlled by selectively connecting one or more hydrocyclones to control the flow rate or to impart shear on the biofilm media. In a non-limiting example, the selector 90 can be configured to receive a liquor containing biofilm (for example, PAC or GAC with biofilm) and to shear off the biofilm from the support media, returning the media via the recycle stream to the BP 40 (or UBZ 42, shown in FIG. 9; or BF 41, shown in FIG. 14).

The augmentor 95 can include a device that applies a bioaugmentation process, or a nutrient or cofactor adding process. The augmentor 95 can include a devices that adds a combination of microbes, enzymes and cofactors to the constituents. The bioaugmentation process can include adding microorganisms that can, for example, biodegrade recalcitrant molecules in the constituents. The added microorganism can include a variety of different microorganisms that can biodegrade a variety micropollutants or nano-pollutants in the constituents. The augmentor 95 can include a device that adds one or more types of nutrients or cofactors to the constituents to promote enrichment and growth of microorganisms. The cofactors can include enzymes such as, for example, proteinic enzymes, proteidic enzymes, or any other cofactors that can promote enrichment and growth of the microorganisms.

As seen in FIG. 6, the apparatus can include a suspended biological treatment step (for example, in the BP 40) with a solids-liquid separation step (for example, SLS 50) that can be based on settling or clarification. The apparatus can contain an advanced oxidation process pretreatment step (for example, AOP 10). The apparatus can include a coagulation or a polymer addition step (for example, C/P 20). The apparatus can include a powdered activated carbon step (for example, PAC 30) before biological treatment. Within the biological treatment step (for example, BP 40) a single or a plurality of media can be included and mixed. The media can be included in series or mixed altogether. Each media can include, for example, the carrier 200 (shown in FIG. 5). Air can be added (for example, gas source 45) to meet oxygen demand requirements. The apparatus can include an election acceptor such as, for example, oxygen (O₂), nitrate, nitrite, ferric ion, oxidized forms of heavy metals desired to be reduced, or carbon dioxide (CO₂). The apparatus can include an electron donor such as, for example, carbonaceous substrate, non-carbonaceous substrate, reduced compounds such as ammonium ion, sulfide ion, ferrous ion, reduced forms of heavy metal ions desired to be oxidized, co-substrate, cofactors, or micronutrients.

In the apparatus in FIG. 6, liquid can be separated from the PAC, carriers and solids by sedimentation (for example, SLS 50). Separated solids can be recycled with a portion of the recycle stream sent to a physical selection process (for example, selector 90) and another portion of the recycle stream sent to the biological treatment process (for example, BP 40). A chemical, physical or biological pretreatment process (for example, pretreator 80) can be included in the supply feed between the liquid-solid separation process (for example, SLS 50) and the physical selection process (for example, selector 90) to allow for solids retention separation as well as biofilm control through, for example, shear application during separation. Addition of chemical or biological agents before the physical selection step (for example, selector 90) can increase the efficiency in biofilm thickness control within the physical selection step (for example, selector 90). Selected solids can be returned to the biological treatment step (for example, BP 40). Bioaugmentation of organisms, additional nutrients or cofactor can be added to the system at any point or location (for example, augmentor 95).

After the solid-liquid separation (for example, SLS 50) a filtration step (for example, PF 60) can be added, which can include, for example, sand filtration, GAC, BAC or other filtration technologies. A disinfection step (for example, D70) can follow the filtration step. The disinfection step can include a technology such as application of UV energy on the effluent line.

According to one or more non-limiting examples of the technological solution (including, for example, the apparatus in any of FIGS. 6 to 14), a biofilm thickness in biofiltration can range from about 1 μm to about 50 μm, and as much as 500 μm), a thin biofilm can have a thickness ranging from about 5 μm to 50 μm, a thick biofilm can have a thickness of about 50 μm to 500 μm, a turbidity influent ranging from 0.5 to 5 NTU measured using a turbidimeter, a turbidity effluent ranging from 0.05 NTU to 0.1 NTU, a TOC in influent ranging from 0.2 to 10 mg/L, a color ranging from 20 to 60 mgPt/L (Platinum Cobalt Units on the Hazen Scale), an ozone or oxidant concentration from 0.5 to 1.5 mg O₃/mg DOC or dissolved organic carbon removed or from 0.1 to 0.2 mg O₃/mg Pt color removed, a shear condition ranging from 50 S−1 to 500 S−1, a backwash rate and frequency (based on head loss) of about once every 24 hours to longer durations between backwashes (with head loss being measured using a piezometer or calculated based on water levels in a filter cell), a backwash flow from 4 to 25 gpm/ft², an air scour rate of about 3 to cfm/ft², a hydraulic loading rates from 1 to 20 m/h, an HRT from 5 to 20 min for drinking water, an EBCT from 2 to 4 min for readily degradable constituents, 5 to 30 min for slowly degradable constituents and as much as 60 min or higher in reuse applications, a Kₛ from 10 to 100 μg/L for micropollutants, a Polyfluoroalkyl substance (PFAS) of 10 to 100 ng/L, or a N -nitrosodimethylamine (NDMA) from 0.01 to 0.10 μg/L. The turbidity effluent range can be increased to about 3 NTUs in certain applications to account for an upper bound that exceeds a 5 mg/L TSS (total suspended solids) threshold that many wastewater plants may need to meet. The influent turbidity can have values as high as 10 NTU (or higher) for applications such as wastewater biological filtration applications.

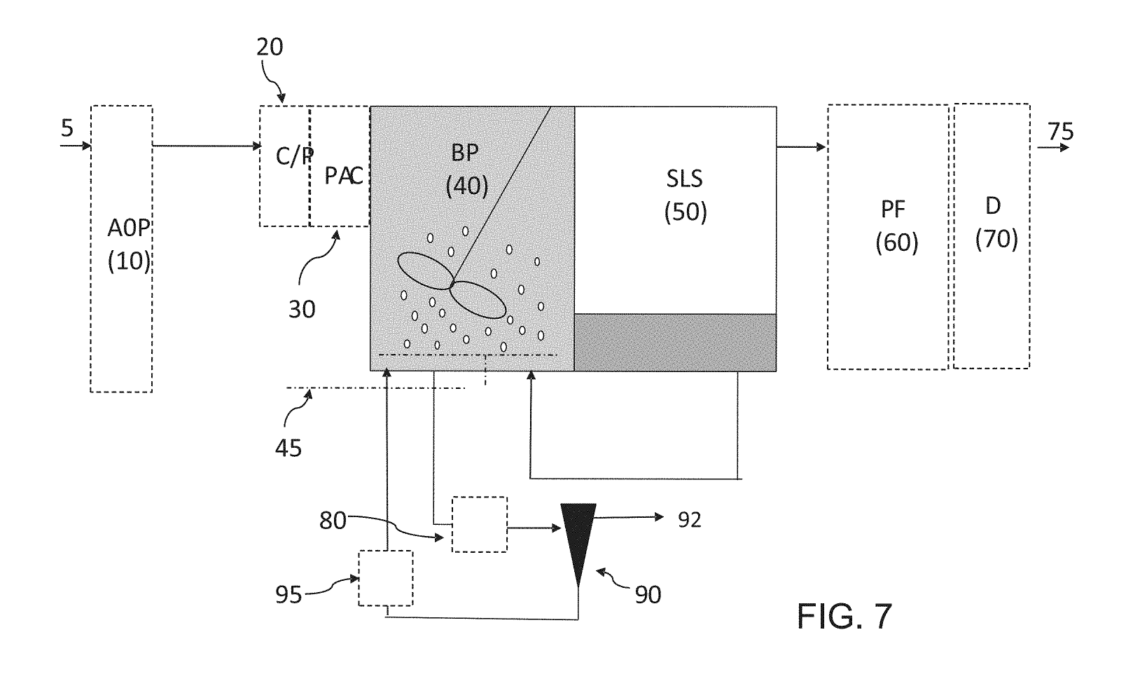

FIG. 7 shows another example of a water

treatment apparatus constructed according to the principles of the disclosure. This apparatus is similar to the apparatus in FIG. 6, except that the input of the pretreator 80 can be connected directly to an output of the BP 40. Alternatively, the first input of the selector 90 can be connected directly to the output of the BP 40. In this example, the pretreatment process (for example, pretreator 80) or physical selection process (for example, selector 90) can be applied directly on the biological treatment step (for example, BP 40).

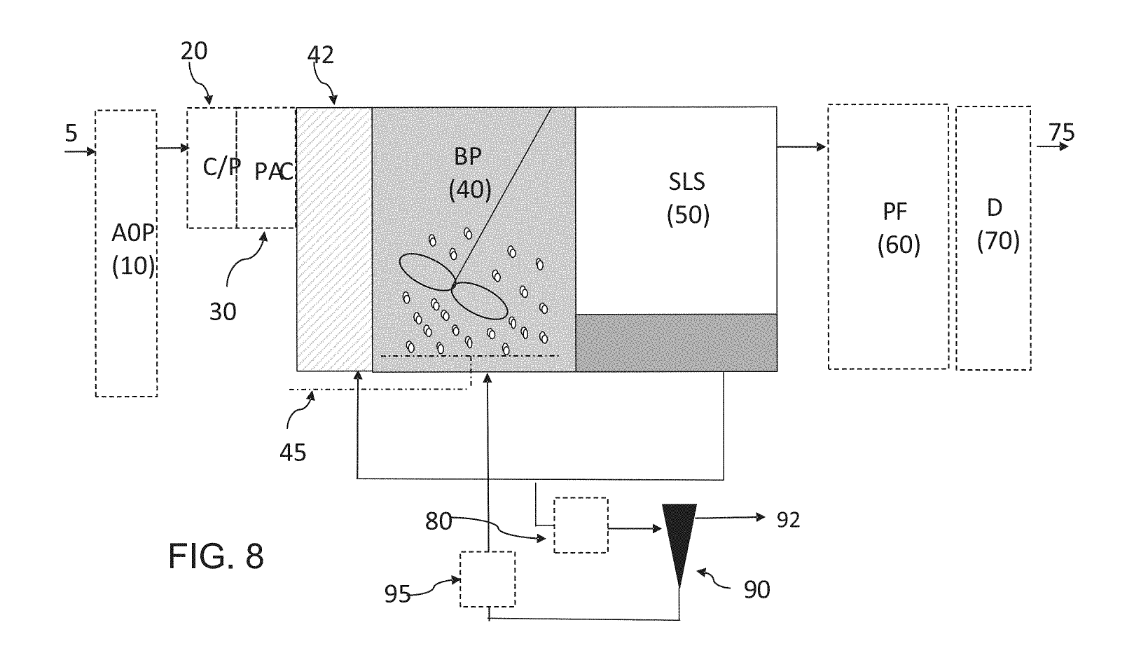

FIG. 8 shows yet another example of a water treatment apparatus constructed according to the principles of the disclosure. The apparatus includes a suspended biological treatment step (for example, BP 40) with a dedicated zone for uncontrolled, thicker biofilms (UBZ) 42. The apparatus is similar to the apparatus in FIG. 6, except that this apparatus includes the UBZ 42 and a portion of the recycle stream is fed from the SLS 50 to the UBZ 42, instead of the BP 40, as seen in FIG. 6. The UBZ 42 can included in a portion of the BP 40, or provided as a separate unit. The BP 40 can include a zone with controlled biofilm. The UBZ 42 can include a biofilm system, such as, for example, the carrier 200 shown in FIG. 5. The BP 40 can include a second or additional medium or carrier. The second or additional medium or carrier can travel in both the uncontrolled zone (for example, UBZ 42) and the controlled zone (for example, BP 40).

As seen in FIGS. 7 and 8, the apparatus can include the C/P 20 and/or the PAC 30 to add a chemical reactant prior to supplying the liquid mixture to the BP 40 containing multiple biofilms (for example, plurobiofilms) in series, or optionally where one biofilm can move between multiple series compartments and another biofilm that can be localized to a single compartment. At least one biofilm can be a biological floc or granule, where the floc or granule is self -agglomerated or grown on a chemical floc nucleus. An optional solids classification device such as a hydrocyclone or screen can be included to separate the media from the floc or the sheared biofilm.

FIG. 9 shows yet another example of a water treatment apparatus constructed according to the principles of the disclosure. This apparatus is similar to the apparatus in FIG. 7, except that this apparatus includes the UBZ 42 and a portion of the recycle stream is fed from the SLS 50 to the UBZ, as well as the recycle stream from the augmentor 95 (or directly from the selector 90).

In FIGS. 8 and 9, the treatment processes can include a suspended biological treatment step (for example, BP 40) with a dedicated zone (for example, UBZ 42) for uncontrolled, slightly thicker biofilms (either upstream or downstream of a controlled biofilm) and with a solids -liquid separation step (for example, SLS 50), which can include settling or clarification. In the apparatus shown in FIG. 8 or 9, a carrier or media with more unprotected versus thicker biofilm (such as, for example FIG. 5) can be included in the dedicated zone UBZ 42. A second medium or carrier can be included and allowed to travel to both zones (controlled and uncontrolled biofilm thickness zones). The biofilm growing on this latter carrier can be sheared by the first carrier within the dedicated zone UBZ 42. In the biological zone BP 40 (without the first carrier), a lower shear or abrasion can take place, or a biological or chemical action can take place on the carrier. By controlling the recycle rate for the solids return from the solid-liquid separation (for example, SLS 50) to the biological treatment step (for example, BP 40), a third abrasion process (or other biological or chemical action) can be carried out on the second carrier. The selector 90 can be configured to impact biofilm thickness on the second medium or carrier. By controlling the choice of zoning in the apparatus, the optimal separation of solids retention time, hydraulic retention time or hydraulic loading rate can be established. Choice of zoning in the apparatus can be controlled by, for example, controlling the volume of the controlled biofilm zone BP 40 compared to the volume of the uncontrolled biofilm zone UBZ 42, controlling the rate(s) of influent(s) to the UBZ 42 or BP 40, or controlling the rate(s) of effluent(s) from the UBZ 42 or BP 40.

In FIGS. 6-14, the zones, recycle lines and returns are merely non-limiting examples of the technological solution and other examples of the disclosure are contemplated. For instance, the apparatus or process can be configured to include multiple series, parallel, distributary or tributary steps or devices.

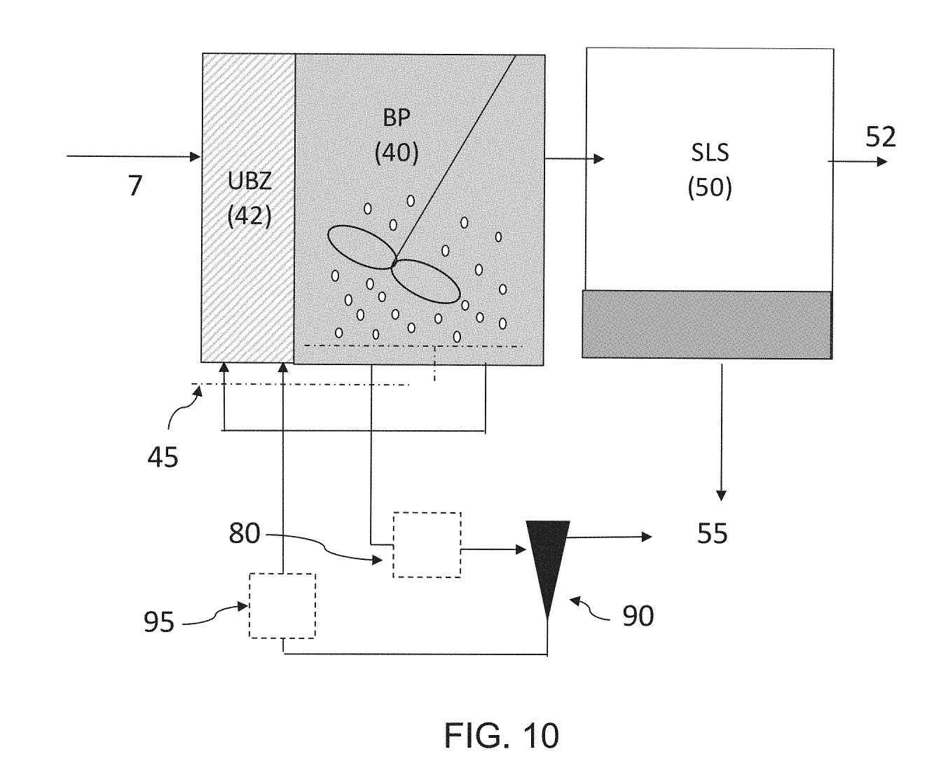

FIG. 10 illustrates a further example of a water treatment apparatus constructed according to the principles of the disclosure. In this apparatus, the UBZ 42 can include an anoxic zone. The anoxic zone can be kept anoxic and allow for the retention of an anammox biofilm. The BP 40 can include an aerobic or an anoxic zone. The BP 40 can promote short-cut nitrogen removal from the treatment process.

Referring to FIG. 10, a suspended biological treatment step (for example, BP 40) can include multiple carriers or medium for the removal of nutrients in which the dedicated zone (for example, UBZ 42) can be kept anoxic to allow for the retention of anammox biofilm. The process (and apparatus) can partially retain autotrophs autotrophic bacteria or heterotrophic bacteria on the first carrier, but the autographs or heterotrophs can reside mostly on the second medium or carrier. The different carriers (for example, two carriers) can shear outside biofilm off each other by abrasion. The second carrier can float to the controlled zone (for example, in BP 40) in which oxygen can be added (for example, by gas source 45) to allow for aerobic ammonium oxidation to occur or a carbon source can be dosed to allow for denitrification. Given the thin biofilm being maintained on the second carrier and in case of an aerobic zone, nitrite oxidizing bacteria can be out-selected to allow for short-cut nitrogen to occur.

FIG. 11 shows a further example of a water treatment apparatus that is constructed according to the principles of the disclosure. The apparatus in FIG. 11 is similar to the apparatus in FIG. 6, except that the SLS 50 can be omitted and the BP 40 can include a membrane filtration unit (MB) 47. The MB can be included internally in the BP 40, or located external to the BP 40. The MB 47 can include, for example, a ceramic or polymer membrane filter or a disc filter. Influent to the MB 47 can be filtered and the filtered effluent can be fed directly to the output 75 or to the PF 60 or D 70. As seen in FIG. 11, a recycle stream can be fed from an output of the BP 40 partially to an input of the pretreator 80 or selector 90 and partially supplied to an input of the BP 40.

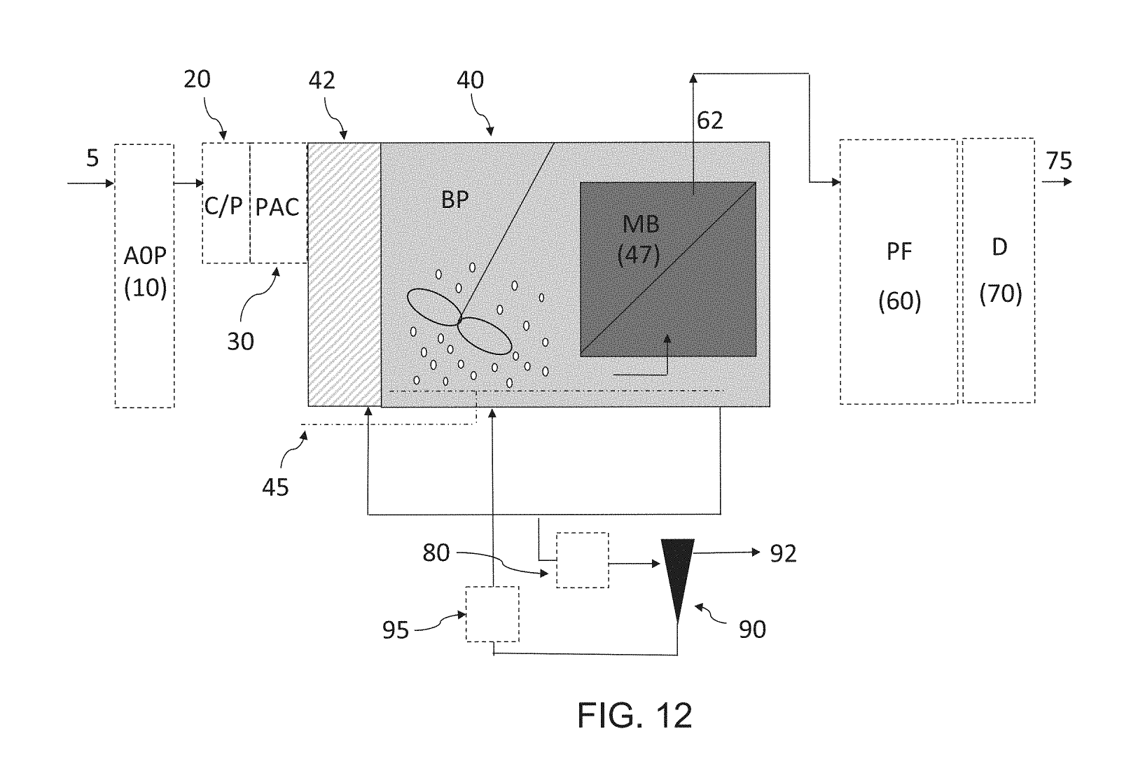

FIG. 12 shows a still further example of a water treatment apparatus that is constructed according to the principles of the disclosure. That apparatus in FIG. 12 is similar to the apparatus in FIG. 11, except that includes the UBZ 42 and a recycle stream is fed from an output of the BP 40 partially to the UBZ 42 and partially to the pretreator 80 or selector 90.

In FIGS. 11 and 12, the treatment processes can include a suspended biological treatment step (for example, BP 40) with a solids-liquid separation step (for example, MB 47) that includes membrane filtration, which can include ceramic or polymeric membranes. As seen, the treatment processes can contain an optional advanced oxidation process (for example, AOP 10) as pretreatment as well as an optional coagulation or polymer addition point (for example, C/P 20) or a powdered activated carbon addition point (for example, PAC 30) before biological treatment (for example, BP 40). Within the biological treatment step (for example, BP 40) a single or multiple media or carriers can be included and mixed. Air can be added (for example, gas source 45) to meet oxygen demand requirements. Liquid can be separated from PAC, carriers and solids by sedimentation. Recycled solids can be sent partially through an optional physical selection step (for example, selector 90) or with optional chemical, physical or biological pretreatment (for example, pretreator 80) to allow for solids retention separation as well as biofilm control through for example shear application during separation in the apparatus. The physical selection step (for example, selector 90) can be applied directly on the biological treatment step (for example, BP 40). Addition of chemical or biological agents (for example, pretreator 80) before the physical selection step (for example, selector 90) can increase the efficiency in biofilm thickness control within the physical selection step (for example, selector 90). Selected solids can be returned to the biological treatment step (for example, BP 40). Bioaugmentation of organisms, additional nutrients or cofactor can be added to the process at any point or location (for example, augmentor 95). After the solid-liquid separation (for example, MB 47) a filtration step (for example, PF 60) can be carried out. The filtration step can be followed by a disinfection step (for example, D 70) on the effluent line before outputting an effluent at the output 75. The use of physical abrasion can be replaced by chemical or biological reactions in any of the examples of the apparatus or process.

In FIG. 12, the apparatus (and process) include a suspended biological treatment step (for example, BP 40) with a dedicated zone (for example, UBZ 42) for uncontrolled, thicker biofilms and with a solids liquid separation (for example, MB 47) that includes membrane filtration. Within this apparatus and process, carriers or media with more protected versus thicker biofilm (such as, for example, shown in FIG. 5) can be included in a dedicated zone (for example, UBZ 42). A second or additional medium or carrier can be included and allowed to travel to both zones, such as, for example, the controlled zone in BP 40 and the uncontrolled biofilm thickness zone UBZ 42. The biofilm growing on this latter carrier can be sheared by the first carrier within the dedicated uncontrolled zone (for example, UBZ 42). In the following biological or controlled zone (without first carrier), a lower shear and abrasion can take place. By controlling the recycle rate for the solids that are returned from the solid/liquid separation (for example, MB 47) to the biological treatment step (for example, BP 40) a third abrasion can be carried out on the second carrier. A physical selection step (for example, selector 90) can be used as a fourth way of impacting biofilm thickness on the second medium or carrier. By the right choice of zoning (for example, controlling volume of controlled biofilm zone compared to volume of non-controlled biofilm zone), the right separation of solids retention time and hydraulic retention time can be established. When working with membrane reactors (such as, for example, the MB 47), within the second zone (for example, BP 40) scouring of the membrane by the media can occur to, not only control biofilm on the carrier, but also mitigate biofouling of the membrane.

FIG. 13 illustrates a still further example of a water treatment apparatus that is constructed according to the principles of the disclosure. The apparatus can include a biological processor (BF) 41. The BF 41 can include a biofiltration system. The biofiltration system can include a housing containing a filter media, pores, and biofilm support media such as, for example, granular activated carbon (GAC). An input of the BF 41 can be connected to the output of the PAC 30, C/P 20, or AOP 10. The input of the BF 41 can be connected directly to the wastewater 5 influent. An output of the BF 41 can be connected to an input of the D 70 or the output 75.

FIG. 14 illustrates a still further example of a water treatment apparatus that is constructed according to the principles of the disclosure. This apparatus can include the BF 41, including a plurality of inputs 710 for receiving air from, for example, one or more gas sources (for example, gas source 45, shown in FIG. 6). This apparatus can be included in a backwash cycle. This apparatus can be included in any of the apparatuses shown in FIGS. 6-12.

In FIGS. 13 and 14, the apparatus includes a multimedia filter with biofilm control during a normal cycle (shown in FIG. 13) and a backwash cycle (FIG. 14), respectively. The media can be selected to apply different abrasion forces on the media to establish different biofilm thicknesses. During the backwash cycle (shown in FIG. 14), media can be separated and a thin biofilm can be established within the BF 41 through for example air scour (for example, via air at inputs 110) or through the exposure to chemical or biological agents allowing for thinner biofilms to establish. In addition, within the backwash cycle (FIG. 140 media can be transferred to an optional selector 90 that can allow for solid separation and additional biofilm thickness control. A pretreator 80 can apply physical, chemical or biological approaches before sending constituents to the selector 90. An additional pretreator 80 or augmentor 90 can be included in the backwash cycle.

The BF 41 can include, for example, a continuous filtration system with internal cleaning. The BF 41 can include, for example, a discontinuous backwash filter. The BF 41 can include a biofilm system that includes a plurality of biofilms arranged in series, in parallel, a combination of in series and in parallel, a tributary configuration, or a distributary configuration to provide for specific and targeted substrate removal using chemical, physical or biological means. The tributary configuration can be implemented for growing specific biofilms or degrading specific pollutants. The distributary configuration can be implemented for managing or controlling hydraulic or solids loading rates or solids residence times.

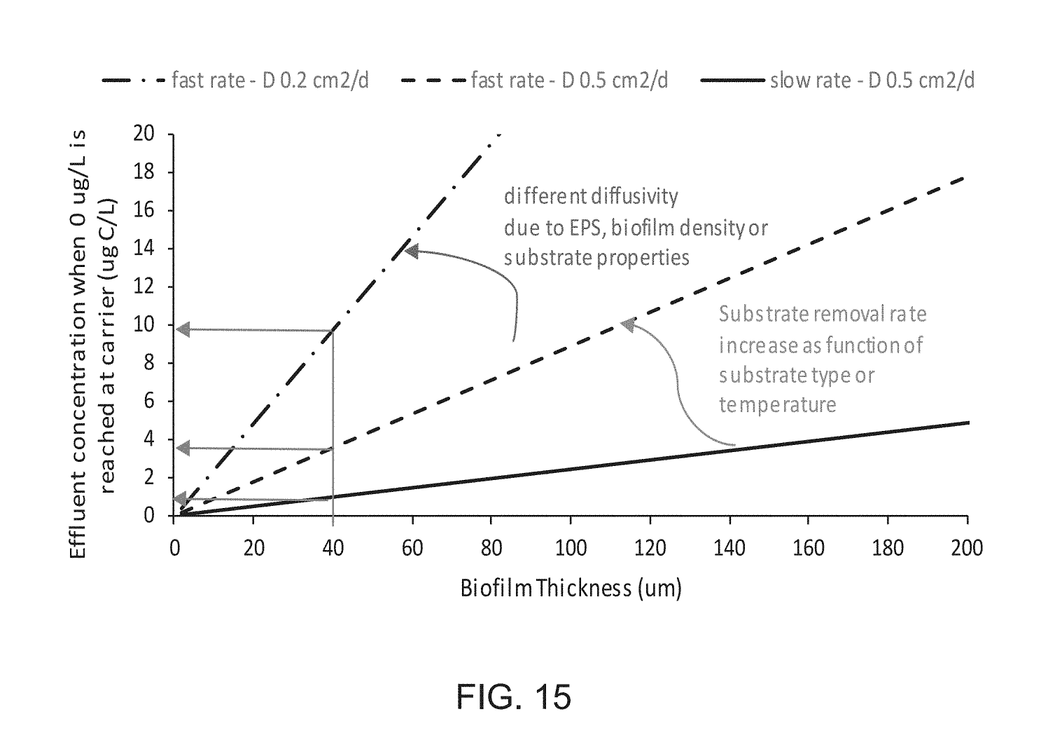

FIG. 15 illustrates an example of effluent quality as a function of biofilm thickness. The diagram illustrates an example of a scenario of fast and slow degrading substrates. When the flux of substrate to a biofilm is smaller than a diffusion rate within the biofilm, which in reality can be most biofilm systems, the substrate removal rate by the organisms equals the diffusion rate through the biofilm. Effluent concentrations, therefore, are dependent on the diffusion rate or microbial activity through the biofilm and the biofilm thickness. In general, the thicker the biofilm, the higher the effluent concentration will be as more diffusion limitation is applied. In addition, the faster the substrate removal rate, the thinner the biofilm needs to be to meet a similar effluent quality. For the example given in FIG. 15, when the substrate removal rate is four time faster for substrate 1 compared to substrate 2, to reach similar effluent quality a biofilm thickness for substrate 1 which is four times thinner than substrate 2 needs to be targeted. It is noted that, when operating under optimized biofilm thickness for substrate 1 (fast rate), the biomass limitation will occur for substrate 2 when the surface area is limited.

As seen in the diagram in FIG. 15, effluent concentration increases linearly with increasing biofilm thickness. As shown by the line diagrams, the fast rate example of a substrate removal rate can be four times faster than the slow removal rate. The diagram shows an example where 0 ug/L substrate is reached at the carrier location and where biomass is not limited for the substrate load that is applied. As seen, the effluent concentration can be significantly higher with different diffusivity due to extracellular polymeric substances (EPS), biofilm density or substrate properties; and, less so with substrate removal rate increase as function of substrate type or temperature. When the flux of substrate to a biofilm is smaller than a diffusion rate within the biofilm, the substrate removal rate by the organisms can equal the diffusion rate through the biofilm. Effluent concentrations, therefore, can be dependent on the diffusion rate or microbial activity through the biofilm and the biofilm thickness. In general, the thicker the biofilm, the higher the effluent concentration will be as more diffusion limitation is applied. In addition, the faster the substrate removal rate, the thinner the biofilm needs to be to meet a similar effluent quality.

When operating under optimal biofilm thickness for substrate 1 (fast rate), biomass limitation can occur for substrate 2 when the surface area is limited. In this case, at least two options might be available, including: (1) providing about 4 times more surface area to accommodate biofilm to remove substrate 2 at slower rate and thinner biofilm; or, (2) providing sheltered biofilm area where biofilm can be about 4 times thicker than optimal for substrate 2 to accommodate optimal kinetics for substrate 2 while managing substrate thickness for substrate 1 in non-sheltered biofilms and thus thinner biofilms.

Substrate removal rates can be determined by substrate type, concentration or organism growth rates on such substrate or environmental conditions impacting microbial growth, such as, for example, temperature, pressure, or availability of micronutrients.

If a change occurs in a biofilm structure or composition, the diffusion rate will be impacted and the dynamics between biofilm thickness and effluent concentration will change.

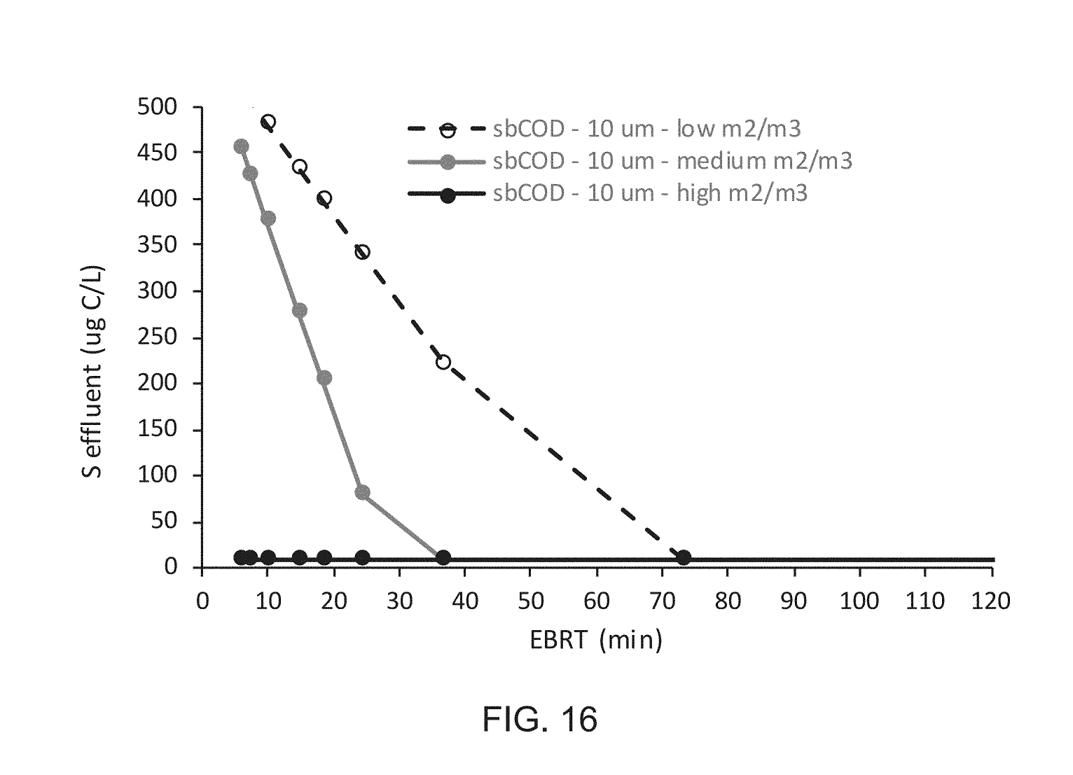

FIG. 16 illustrates an example of effluent quality as a function of empty bed residence time (EBRT) for different media types, including media having different surface areas. A media with a high surface area to volume ratio can maintain thinner biofilms for the same or similar overall mass, or, as shown in the Figure, a higher mass for the same thickness (for example, 10 μm), thereby supporting lower bulk substrate effluent concentrations. A combination of media types can thus be used to manage specific removal based on influent substrate concentration, degradability or SRT considerations.

Effluent quality can be determined by diffusion kinetics when enough biomass or biofilm is present. The concentration can be dependent on the biofilm structure and thickness. Improving effluent quality can be done by managing biofilm thickness. When biomass is limited, decreasing EBRT can result in increased effluent quality as the apparatus (or process) is loaded higher than the substrate removal rates, which can be determined by diffusion. In case of biomass limitation, EBRT can be used as control parameter for effluent quality, which can be done to the determined effluent concentration set by the diffusion kinetics. The use of media with increased surface area can lead to management of biofilm thickness (diffusion) as a major control variable.

In the biofilm system according to the present disclosure, a biofilm thickness can be managed to have sufficient biomass to achieve target substrate degradation or effluent concentrations. As long as the effluent concentration decreases at increased biofilm thickness, biomass limitation can be apparent (for example, as shown in FIGA. 1A, 1B). An optimal biofilm thickness can be achieved at minimal effluent quality. Diffusion can become a major limitation when operating at thicker biofilms than optimal. Based on Fick's law of diffusion, effluent quality can increase linearly with biofilm thickness once a biofilm has enough area or volume to overcome biomass limitation. As a result, overall degradation rates can decrease rapidly with biofilm thickness.

FIGS. 3A and 3B show the effluent concentration and pollutant degradation rates for a non-limiting example. The example was based on bacterial flux of 0.2 mg C/m2/d, calculated based on cell radius of bacterium of 0.39 μm, 20% dry matter content, 50% carbon content of cell dry matter and yield of 0.67 g COD/gCOD. A substrate gradient of 0.88 (mg C/L)/cm biofilm thickness was calculated based on a diffusivity of glucose as model compound of 0.55 cm2/d. In this example, an effluent of 1 μg C/L can be achieved with a biofilm thickness lower than 20 μm, given enough surface area to overcome biomass limitation.

According to a non-limiting example of the technological solution, a biofilm system can have multiple biofilms of distinct thicknesses and solids residence times for the removal of carbonaceous material, inorganic substrates, nutrients or micropollutants (or nanopollutants). At least one of the biofilms can be controlled to maintain a certain thickness (for example, between 0 and 500 μm). The latter can be achieved by selection of media with specified ridges or grids, allowing for the biofilm to meet a specified maximum thickness before being corrected by abrasion or by chemical or biological means. These structures can be diverse in shape, form, or grids, and can result from molding, casting or firing processes used to produce the media. In addition to the selection of specific media, physical abrasion, chemical treatment or the use of biological agents can be used to control biofilm thickness.

Multiple solids residence times can be maintained by managing the ratio of masses or volumes of multiple biofilm thicknesses, or by managing different tank volumes or hydraulic residence times for the multiple biofilms. Other methods for maintaining multiple solids residence times can include, for example, use of metabolic responses by the organisms degrading substrates or targeting degradation rates or residual substrate concentrations. This can be based on direct measurements, including concentration measurements of the target compound, or it can be based on surrogate measurements

A bulk liquid concentration or a surrogate measurement related to a limiting substrate concentration can be minimized or controlled by, for example, adjusting a flow or a mass rate or frequency of operation of a device or physical, chemical or biological mechanism controlling the biofilm thickness in the apparatus according to the principles of the disclosure.

The flow or mass rate, or the frequency of operation of the device controlling biofilm thickness can be increased as long as the bulk liquid concentration or its surrogate measurement is above a minimum concentration and the decreasing response in the bulk liquid concentration or surrogate measurement is observed. This can be based on achieving thinner biofilm without moving into biomass limitation (for example, as shown in FIGS. 1A, 1B). When an increasing effluent quality with decreasing biofilm thickness is encountered, the biomass limitation will have been reached. Therefore, a set-point concentration can be determined above the minimum bulk liquid concentration or surrogate measurement concentration required to maintain the minimum mass of active organisms for substrate degradation. The maximum biofilm thickness can be determined based on achieving sufficient biomass to maintain target removal rates or effluent quality.

The biofilm can include an agglomeration of organisms. The biofilm can be a suspended floc, a granule or an attached growth biofilm.

The selection or out-selection of organisms can be managed by, for example, adjusting the biofilm thickness control device operation based on the product concentration. For example, in case of nitrifiers, nitrite can be used as an indicator to control biofilm thickness and out-select nitrite oxidizing organisms and select for ammonium oxidizing organisms. At decreased nitrite, and thus increased presence of nitrite oxidizing organisms, increased biofilm thickness control can be applied to target thinner biofilms to out-select nitrite oxidizing bacteria. In this example, ammonium can be used as a signal to make sure the mass of aerobic ammonium oxidizing organisms is not limited while out-selection other organisms. The same process can be applied to other examples where management of biofilm thickness can be used to out-select one organism from other, different organisms.

Niches can be created within a biofilm to provide a multifunctional biofilm. The control of biofilm thickness can allow for balancing of the different functions or to control competition between organisms. Through biofilm thickness control, the mass and content of the organisms residing on the surface of the biofilm can be affected. The organisms can include aerobic organisms and their location within the biofilm can be driven by oxygen gradients or anoxic. The organisms can include anaerobic organisms where electron donors or competitive substrates can control their location within the biofilm.

The flow or mass rate or frequency of the operation of a device controlling the biofilm thickness can be adjusted based on, for example, head loss or pressure differential. Head loss is often a good surrogate measurement for increased turbidity or increased biofilm thickness. However, in some cases head loss might be an earlier limitation of filters (or turbidity) than diffusion limitation, thus causing potentially biomass limitation when control is based on head loss. It is thus important to balance overall physical throughput limitation with biomass limitation and diffusion limitation. Therefore, two different approaches may be available for managing turbidity or biofilm thickness, thus decoupling a main feature of solid/liquid separation and turbidity removal in a filter from biofilm thickness control, such as, for example, by using air scouring or other physical, chemical or biological means.

A surrogate measurement can be used to control biofilm thickness. The surrogate measurement can be based on, for example, pressure, fluorometry, spectrometry, a solute or gas concentration, or turbidity.

A target substrate for which a biofilm thickness or solids residence times is to be optimized can be an electron donor, electron acceptor or a carbon source.

A biofilm thickness can be controlled based on, for example, physically limiting a maximum biofilm thickness using specialized carriers or textiles that create grid, super structures or a certain porosity allowing different degrees of exposure to shear and substrate levels within one biofilm (such as, for example, the carrier 200 shown in FIG. 5).

Multiple biofilm thicknesses can be created within a single carrier in which one or more biofilm thicknesses can be directly controlled through specified structures on the carrier. Uncontrolled biofilms can be feasible within protected areas of the carrier (for example, carrier 200, shown in FIG. 5).

A carrier (or biofilm system) that can be used to create multiple biofilms can include, for example, powdered activated carbon, granular activated carbon, anthracite, sand, lava rock, green sand, ceramic media (for example, based at different temperatures), glass, expanded clay, calcified media such as sea shells, synthetic or plastic media, naturally occurring media, other impregnated or encapsulated natural or synthetic media, or a combination thereof. The media can contain special micro or macronutrients such as, for example, calcium, magnesium, iron, copper or other metals or catalysts, phosphorus, sulfur or other inorganics, or, light, heat, magnetic, or electromagnetic or radiation producing media that can change the rates of reaction within the biofilms. Encapsulated media can include specialized bacteria or organisms, such as, for example, fungi or algae, to degrade pollutants of concern. The encapsulation can be adjusted to manage or enhance pollutant sorption or adhesion characteristics by increasing surface attraction of the pollutant within the encapsulated material, thus making it more accessible to the encapsulated microorganism. Thus, the encapsulation can serve multiple purposes, such as, for example, for solid-liquid separation, protective coating for organisms, attracting substrates, managing diffusion characteristics, or sensing (such as, for example, sensing color change when a pollutant is internalized).

A device that can control a biofilm thickness can be based on or include managing shear or abrasion on the biofilm using mechanical or hydraulic approaches including but not limited to backwashing, flushing, scraping, air or water scouring, cyclones, or screens.

A device that can control the biofilm thickness can be based on or include controlled addition of chemicals such as oxidants, organic polyelectrolytes, inorganic coagulants, organic or inorganic flocculants, acids, bases, free nitrous acids, cations, anions, metal, nutrients, enzymes, ATP or other cofactors or growth promotors, growth inhibitors or toxicants.

A device that can control the biofilm thickness can be based on or include controlled addition of chemicals that can target a gross biofilm thickness or can specifically stimulate, inhibit or kill a certain organism or group of organisms including but not limited to heterotrophs, autotrophs, nitrifiers, denitrifiers, methanotrophs, manganese oxidizers, iron oxidizers, anaerobic methanogens or fermenters. These can include organisms with specialized abilities to degrade micropollutants.

The degradation of micro-pollutant can be controlled, for example, using bioaugmentation of acclimated biofilms or biomass or addition of specialized enzymes, cosubstrates or nutrients. Bioaugmentation products or other additives can be added for example at the end of the backwash cycle (as shown, for example, in FIG. 14).

A device that can control biofilm thickness or solids residence time can be based on or include the out-selection of targeted organisms through mechanical shearing using cyclone or screens for removing an outer layer of the biofilm at a faster rate compared to the inner layers and thus uncoupling of sludge retention times. The device can maintain a maximum biofilm thickness formed on top of a carrier applied in the physical separated.

Application of a biofilm to physical forces within an external selector (for example, selector 90), such as, for example, screens or cyclones or within the device controlling biofilm thickness through abrasion, can result in the formation of denser biofilms that can impact the diffusion resistance and increase a microbial cell concentration within the biofilm.

A device for controlling a biofilm thickness can be based on substrate composition control through chemical processes such as ozonation, chlorination, chloramination, permanganate addition, peroxidation, vacuum, UV or other oxidation or advanced oxidation processes. Chemical reducing processes or advanced reducing processes can also be used (such as, for example, for refractory materials in a higher oxidation state), especially if the desire is to dehalogenate compounds or to reduce a complex oxidized chemical (for example, ringed compounds) that are resistant to further reactions. Reducing reactions can be achieved using reactive metals, hydrogen -based compounds, reducing radicals, electron or proton beams, or other chemicals. Substrate composition is typically the characteristics of a chemical or particle found in the influent that chemical processes can be modified to make the chemical more labile or biodegradable or to mix chemical and biological processes. The chemical process can also be applied during a backwash step or in the recycle (of clarified water or media) to create more targeted chemistries of refractory material in the water that have for example not degraded after a single pass of treatment. The chemical treatment can also be used to impact also the biofilm on the media that are subject to backwash or recycling (within reactors or between multiple reactors). These chemicals can be inhibitors or stimulants or cosubstrates or nutrients. These chemicals can also be any oxidant or reductant mentioned above.

The biofilms are maintained on filters, reactor vessels, polymeric or ceramic membrane reactors, deep clarifiers, fixed or moving bed processes, fluidized bed processes, trickling or biological aerated filters, continuous or intermittent backwash filters, fuzzy filters, cloth or fabric media, disc filters, membrane biofilm filters, or suspended processes or a combination of fixed and suspended processes.

A device that controls the biofilm thickness can be based on or include controlled addition of biological agents such as bacteria, fungi, algae, phages, protozoa or other higher life form predators, organisms or molecules that facilitate biofilm formation or microbial competition through quorum sensing or bioaugmentation to control gross biofilm thickness or microbial composition.

A biofilm thickness can be managed in, for example, a drinking water treatment plant, a water reuse plant, a distribution system for drinking water, a collection system for wastewater, a wastewater treatment plant, a plumbing system, a natural or constructed wetland, a storm water treatment system, an agricultural buffer, or a river bank filtration system.

A substrate concentration in a bulk or immediate boundary layer of a biofilm can be increased through physical or chemical approaches, including, but not limited to, charge attraction or repulsion, physical or chemical sorption, van der waals forces, proton gradients, or channeling for convection such as with activated carbon or extracellular polymeric substances. Sorption of carbonaceous material or of micropollutants onto extra cellular polymeric substances, activated carbon or other media, can create an increase in substrate concentration or driving force that can result in increased removal rates at increased biofilm thicknesses. Retention time of the compounds can be increased to allow for removal at decreased biomass content. Creating a combination of sorption with biological removal can result in increased substrate removal and achievement of decreased effluent concentrations.

FIGS. 6-14 show examples of an apparatus for water treatment. The apparatus can include a biofiltration process having a media for biofilm retention and a membrane or filter for particle or media separation. The biofilm media can include support. The biofilm media can include powdered activated carbon, GAC, plastic media, ceramic media, sand, anthracite, sponges, rocks, chitin, shells or other suitable materials.

The PAC or GAC can provide adsorption of organic or inorganic materials, including, for example, but not limited to, metals, micropollutants, organic carbon, non -biodegradable or recalcitrant organics.

Polyelectroytes, inorganic coagulants, flocculants or a combination thereof can be applied for coagulation of incoming particulate or colloidal material as a means of improving effluent quality or maintaining increased membrane permeability and flux, or, providing further support for biofilm growth.

Aeration can be included for membrane cleaning or to provide for oxygen transfer as an electron acceptor for biofilm growth or modulation or to maintain multiple biofilm oxidation states.

Sparged gas or electron acceptors such as hydrogen, nitrogen, carbon dioxide, or argon can be provided for membrane cleaning and control of oxidation-reduction potential and dissolved oxygen concentration.

A physical separator can be included to recover a biofilm support media (for example, the carrier 200, shown in FIG. 5) or to provide shear to control biofilm thickness and solids residence time, or to maintain and control the biofilm inventory in the bioreactor.

The physical separator can include a gravimetric device such as a cyclone, centrifuge, settler, screen, filter, or dissolved air floatation.

The physical separator can include an upstream shearing device to modulate biofilm thickness.

The physical separator can provide an inventory that is granular to maintain high membrane permeability and flux and that resists membrane fouling.

The media can provide scouring of the membrane filter surface to maintain high membrane permeability and flux and resist membrane fouling.

The membrane can be polymeric, ceramic or made of other inorganic material, cloth or other fibrous material such as a disc filter.

The membrane can be hollow fiber, flat sheet, flat plate, spiral wound or where the membrane is located in the reactor or in a separate membrane compartment with transfer of solids to and from the membrane tank.

The biodegradation of organics within the different apparatuses and processes can be enhanced with an upstream oxidation or advanced oxidation process. The oxidation can include ozone, UV, hydrogen peroxide, potassium permanganate, or any combination thereof. The biodegradation of organics containing halogens or other recalcitrant material can be enhanced using reducing or advanced reduction processes.

The biofilms can be optimized for growth of probiotic organisms for distribution system stability and for improving human health.

The membrane or filter can be replaced by a clarifier or solids contact clarifier that can return biomass, separated water, or a mixture of biomass and water to the bioreactor, or between two reactors, such as, for example, in internal recycle applications.

The backwash or air scour or surface wash can be applied at multiple levels or heights or depths to provide different solids residence times in a filter. The backwash and air scour can be used for differentiated turbidity removal (for example, of influent colloids OR solids) or for biofilm control (for example, by directly or indirectly controlling SRT). The differentiation can be used by for example focusing backwash for managing turbidity and using air scour for managing biofilms. This differentiation can be key to decouple different functions in a filter intended for managing micropollutants but also receiving a load of particulates and colloids and other material.

Chemicals can be applied to backwash water or the filter feed water to manage biofilm thickness along the depth of a filter.

According to a non-limiting embodiment of the technical solution, an apparatus is provided having a granular media filter preceded by another apparatus that promotes chemical oxidation or chemical reduction of flow entering the filter. The apparatus comprises a biofilm medial having two or more media surfaces carrying different biofilm mass, volume, density or thickness ranges or different solids residence times using sheltered, partly sheltered or unsheltered surfaces to grow biofilms for the removal of carbonaceous material, nutrients, inorganic compounds and/or micro-pollutants, wherein, at least one biofilm mass, volume, density or thickness range is managed using, ridges, grids, macro pore inclusions or micro pore inclusions on media surfaces or within the media, and/or chemical treatment or through the use of biological agents, and/or backwash, air scour or other physical means.

An example of the technological solution includes a method comprising a media -based filtration process that consists of two or more media surfaces carrying different biofilm mass, volume, density or thickness ranges or different solids residence time ranges for the removal of carbonaceous material, nutrients, inorganic compounds and/or micro-pollutants, wherein, at least one biofilm mass, volume, density or thickness is controlled using, ridges, grids or other casting, molding or firing processes, and/or, physical abrasion, chemical treatment or through the use of biological agents, or, at least one solids residence time is controlled by managing the ratio of masses or volumes of multiple biofilm thicknesses, and/or managing different reactor volumes or hydraulic residence times for the multiple biofilms, and/or, metabolic response by the organisms degrading substrates, and/or, targeting degradation rates or residual substrate concentrations, and/or using physical abrasion, chemical treatment or through the use of biological agents.

The biofilm thickness, mass, volume or density can be managed to have sufficient biomass to achieve target substrate degradation or removal rates or effluent concentrations.

The bulk liquid concentration or surrogate measurement related to the limiting substrate concentration can be minimized or controlled by adjusting the flow or mass rate or frequency of the operation of a device or physical, chemical or biological mechanism controlling the biofilm mass, volume or thickness.

The flow or mass rate or frequency of the operation of the device controlling biofilm thickness can be increased as long as the bulk liquid concentration or its surrogate measurement is above the minimum concentration and the decreasing response in bulk liquid concentration or surrogate measurement is observed.

A set-point concentration can be determined above the minimum bulk liquid concentration or surrogate measurement concentration required to maintain the minimum mass of active organisms for substrate degradation.

The selection or out-selection of organisms can be managed by adjusting the biofilm thickness control device operation based on the product concentration; or, where the biofilm mass, volume or thickness is controlled based on physically limiting the maximum biofilm mass, volume or thickness using specialized carriers or textiles that create grid, super structures or a certain porosity allowing different degrees of exposure to shear and substrate levels within one biofilm; or, where multiple biofilm mass, volume or thicknesses are created within a single media or carrier; or where the biofilm is made of self-agglomerating organic and inorganic material in the form of granules, flocs or other structures.

The flow or mass rate or frequency of the operation of a device controlling the biofilm mass, volume or thickness can be adjusted based on head loss or pressure differential.

The surrogate measurement can be pressure, fluorometry, spectrometry, a solute or gas concentration, or turbidity.

The substrate can be an electron donor, electron acceptor or a carbon source.

The carriers can be powdered activated carbon, granular activated carbon, plastic media, ceramic media, sand, anthracite, sponges, rocks, chitin, shells, anthracite, sand, lava rock, glass, expanded clay, green sand, calcified media such as sea shells, synthetic or plastic media, naturally occurring media, other impregnated or encapsulated natural or synthetic or a combination thereof media, media containing special micro or macronutrients such as calcium, magnesium, iron, copper or other metals, phosphorus, sulfur or other inorganics, or, light, heat, magnetic, or electromagnetic or radiation producing media.

The device controlling the biofilm mass, volume or thickness can be based on managing shear or abrasion on the biofilm using mechanical or hydraulic approaches including but not limited to backwashing, flushing, scraping, air or water scouring, cyclones or screens.

The device controlling the biofilm mass, volume or thickness can be based on controlled addition of chemicals such as oxidants, organic polyelectrolytes, inorganic coagulants, organic and inorganic flocculants, acids, bases, free nitrous acids, cations, anions, metal, nutrients, enzymes, ATP or other cofactors or growth promotors, growth inhibitors or toxicants; and, where the chemicals can be applied to the backwash water or the filter feed water to manage biofilm thickness along the depth of the filter.

The device controlling the biofilm mass, volume or thickness can be based on controlled addition of chemicals that can target the gross biofilm mass, volume or thickness or can specifically stimulate, inhibit or kill a certain organism or group of organisms including but not limited to heterotrophs, autotrophs, nitrifiers, denitrifiers, methanotrophs, manganese oxidizers, iron oxidizers or reducers, sulfur oxidizers or reducers, anaerobic methanogens or fermenters.

The degradation of micro-pollutant can be controlled using bioaugmentation of acclimated biofilms or biomass or addition of specialized enzymes, cosubstrates or nutrients.

The device controlling biofilm thickness and/or solids residence time can be based on the out-selection of targeted organisms through mechanical shearing using cyclone or screens removing the outer layer of the biofilm at a faster rate compared to the inner layers and thus uncoupling of sludge retention times.

The composition of the influent to filtration can be controlled through oxidation or pre-oxidation process such as ozonation, chlorination, chloramination, permanganate addition, peroxidation, ultra violet or other advanced oxidation processes, or through reduction or pre -reduction process associated with a reducing agent.

The biofilms filters can be fixed or moving bed systems and reactors, fluidized bed filters, trickling or biological aerated filters, continuous or intermittent backwash filters, fuzzy filters, cloth or fabric media, disc filters, membrane biofilm filters or, a combination of fixed and suspended processes.

The device controlling the biofilm thickness can be based on controlled addition of biological agents such as bacteria, phages, protozoa or other higher life form predators, organisms or molecules that facilitate biofilm formation or microbial competition through quorum sensing or bioaugmentation to control gross biofilm thickness or microbial composition.

The biofilm thickness can be managed in a drinking water treatment plant, a water reuse plant, a distribution system for drinking water, a collection system for wastewater, a wastewater treatment plant, a plumbing system, a natural or constructed wetland, a storm water treatment system, agricultural buffers, river bank filtration.

The substrate concentration in the bulk or immediate boundary layer of the biofilm can be increased through physical and chemical approaches including but not limited to charge attraction or repulsion, physical or chemical sorption, van der waals forces, proton gradients, channeling for convection such as with activated carbon or extracellular polymeric substances.

The biofilms can be optimized for growth of probiotic organisms for distribution system stability and for improving human health.

Backwash or air scour or surface wash can be applied at multiple levels or heights or depths to provide different solids residence times in a filter or to separately manage or control for effluent turbidity and biofilm mass, volume or thickness.

Another example of the technological solution includes a method for water treatment, wherein a biofiltration process is maintained using single or multiple media surfaces, that are in series, in parallel, or as a tributary, that are used for biofilm retention and a membrane, fabric filter or a blanket clarifier is used for solid-liquid separation, and where the influent to the biofiltration process is subject to chemical treatment using a reactant, oxidant or reductant in a manner that the altered influent material can be further treated if necessary within the biofiltration process.

Another example of the technological solution includes an apparatus for water treatment, wherein a biofiltration reactor is maintained using single or multiple media surfaces, that are in series, in parallel, or as a tributary, that are used for biofilm retention; and a membrane, fabric filter or a clarifier is used for solid-liquid separation, and where the influent to the biofiltration reactor is subject to chemical treatment using a reactant, oxidant or reductant in a manner that the altered influent material can be further treated if necessary within the biofiltration process.

The apparatus can include powdered activated carbon, granular activated carbon, plastic media, ceramic media, sand, anthracite, sponges, rocks, chitin, shells, anthracite, sand, lava rock, glass, expanded clay, green sand, calcified media such as sea shells, synthetic or plastic media, naturally occurring media, other impregnated or encapsulated natural or synthetic or a combination thereof media, media containing special micro or macronutrients such as calcium, magnesium, iron, copper or other metals, phosphorus, sulfur or other inorganics, or, light, heat, magnetic, or electromagnetic or radiation producing media.

PAC or GAC can provide adsorption of organic and inorganic material including but not limited to metals, micropollutants, organic carbon, non-biodegradable or recalcitrant organics.

Polyelectrolytes, inorganic coagulants, flocculants or a combination thereof can be applied for coagulation of incoming particulate and colloidal material as a means of improving effluent quality or maintaining increased membrane permeability and flux, or, providing further support for biofilm growth.

Aeration can be provided for membrane cleaning or also provides for oxygen transfer as an electron acceptor for biofilm growth or modulation or to maintain multiple biofilm oxidation states.

Sparged gas or electron acceptors such as hydrogen, nitrogen, carbon dioxide, argon can be provided for membrane cleaning and control of oxidation-reduction potential and dissolved oxygen concentration.

A physical separator can be included to recover biofilm support media or provide shear to control biofilm thickness and solids residence time, or to maintain and control the biofilm inventory in the reactor.

The physical separator can include a device such as a hydrocyclone, centrifuge or a settler, or a screen, filter, dissolved air floatation and, wherein the physical separator could include an upstream shearing device to modulate biofilm thickness.

The physical separator can provide an inventory that is granular to maintain high membrane permeability and flux and resists membrane fouling.

The media can provide scouring of the membrane filter surface to maintain high membrane permeability and flux and resists membrane fouling.

The membrane could be polymeric, ceramic or made of other inorganic material, cloth, mesh or other fibrous material such as a disc filter.

The membrane could be hollow fiber, flat sheet, flat plate, spiral wound or where the membrane is located in the reactor or in a separate membrane compartment with transfer of solids to and from the membrane tank.

The oxidant can be ozone, chlorine, Ultraviolet, hydrogen peroxide, potassium permanganate, or the combination thereof.

The membrane, filter or clarifier, including a lamella or a solids contact clarifier, can be outfitted with a return pipe to the reactor or coagulation zone.

The terms “a,” “an,” and “the,” as used in this disclosure, means one or more, unless expressly specified otherwise.

The term “biological processor,” as used in this disclosure, means a tank, a vessel, a column, a cylinder, a reactor, or any other structure or device that can contain a liquid, a solid and a water treatment process that can include a biological, chemical or physical mechanism to remove or facilitate removal of constituents from water. A “biological processor” can include, for example, a sequencing batch reactor (SBR), a moving bed biofilm reactor (MBBR), a moving bed biofilm membrane reactor (MBB-MR), a membrane bioreactor (MBR), an activated sludge process (ASP), an up flow anaerobic sludge blanket (UASB) reactor, a granular activated carbon (GAC) filter, a disc filter, a ceramic filter, or any other device or process that can contain or facilitate containment or growth of a biofilm for purposes of removing constituents from water.

The term “constituent,” as used in this disclosure, means any organic contaminant, inorganic contaminant, micropollutant, nanopollutant, organic compound, total organic compound (TOC), inorganic compound, molecule, chemical compound, pesticide, drug, cleaning product, industrial chemical, organism, virus, or any other element or article that can be harmful to an organism or the environment, or any element or article that might not be desirable in water to be used for human consumption or for discharge into the environment, such as, for example, into a stream, a river, a wetland, an ocean, or any other waterway, body of water, or the ground.

The term “constituent concentration,” as used in this disclosure, means an amount of a constituent in a unit of water, such as, for example, but not limited to, an amount of a constituent in moles, μg, or mg of the constituent per-liter of water, or a pH level of the water, or the turbidity level in NTUs (nephelometric turbidity units).

The term “control” and its variations, as used in this disclosure with respect to biofilm(s) or constituent(s), includes, but is not limited to, managing thickness, mass, volume or a composition of a biofilm, or mass or concentration of substrate or an influent constituent (feed forward), effluent constituent (feedback), a constituent within a recycle stream, a constituent within a backwash stream, or a constituent within a waste stream. Control can constitute a manual approach, an automatic approach, or approaches using artificial intelligence or self-learning algorithms.

The terms “including,” “comprising,” “having” and their variations, as used in this disclosure, mean including, but not limited to, unless expressly specified otherwise.

The term “pollutant,” as used in this disclosure, means a micropollutant, a nanopollutant, a total organic compound, or a biodegradable pollutant.

Devices that are in communication with or connected to each other need not be in continuous communication or connection with each other unless expressly specified otherwise. In addition, devices that are in communication or connection with each other may communicate or connect directly or indirectly through one or more intermediaries.

Although process steps or method steps may be described in a sequential or a parallel order, such processes or methods may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

While the disclosure has been described in terms of examples, those skilled in the art will recognize that the disclosure can be practiced with modifications in the spirit and scope of the appended claims. These examples are merely illustrative and are not meant to be an exhaustive list of all possible designs, embodiments, applications, or modifications of the disclosure.

We claim:

1. An apparatus for removing constituents from an influent, the apparatus comprising:
a biological processor that receives a water mixture as influent and outputs a liquor;
a solid-liquid separator that receives the liquor and separates the liquor into a liquid and a solid; and
biofilm media that includes at least one media surface, the biofilm media having a biofilm mass, biofilm volume, biofilm density, biofilm thickness, hydraulic retention time or solids residence time,
wherein the at least one media surface grows a biofilm that removes one or more constituents contained in the influent, and
wherein the biofilm mass, biofilm volume, biofilm density, biofilm thickness, hydraulic retention time or solids residence time is controlled by at least one of a physical process, a biological process or a chemical process.

2. The apparatus in claim 1, wherein the biological processor comprises a bioreactor or a biofiltration system.

3. The apparatus in claim 1, wherein the biofilm media has two or more media surfaces, each media surface having a different biofilm mass, biofilm volume, biofilm density, biofilm thickness, or solids residence time.

4. The apparatus in claim 1, wherein the biofilm media includes at least one of a ridge, a grid, a macro-pore inclusion, or a micro-pore inclusion on at least one of the two or more media surfaces or within the biofilm media.

5. The apparatus in claim 1, further comprising:
a pretreator that applies a chemical agent such as ozone, chlorine, ultraviolet radiation, hydrogen peroxide, potassium permanganate or a biological agent to the influent or a recycle stream,
wherein the chemical agent comprises a reactant, an oxidant, or a reductant,
wherein the biological agent comprises a phage, a vector or a virus, and
wherein the physical process or biological process comprises adding the chemical agent or the biological agent to the influent or recycle stream to control the biofilm mass, biofilm volume, biofilm density, biofilm thickness, or solids residence time.

6. The apparatus in claim 1, further comprising:
an augmentor that adds a nutrient or a cofactor to a recycle stream,
wherein the nutrient comprises a trace element, nitrogen or phosphorous,
wherein the cofactor comprises an organic coenzyme or an inorganic metal, and
wherein the biofilm mass, biofilm volume, biofilm density, biofilm thickness, or solids residence time is controlled by the nutrient or cofactor.

7. The apparatus in claim 1, further comprising:
a selector that applies the physical process by shearing the biofilm media to control the biofilm mass, biofilm volume, biofilm density, biofilm thickness, or solids residence time.

8. The apparatus in claim 1, further comprising:
a gas source that applies the physical process by scouring the biofilm media to control the biofilm mass, biofilm volume, biofilm density, biofilm thickness, or solids residence time.

9. The apparatus in claim 1, further comprising:
a backwashing device that applies the physical process by backwashing the biofilm media to control the biofilm mass, biofilm volume, biofilm density, biofilm thickness, or solids residence time.

10. The apparatus in claim 3, wherein at least one of the two or more media surfaces is sheltered, partly sheltered, or unsheltered.

11. The apparatus in claim 3, wherein the constituents comprise at least two of a micropollutant, a nanopollutant, a carbonaceous material, a nutrient, or an inorganic compound.

12. The apparatus in claim 1, wherein the biological processor comprises a bioreactor and wherein the biofilm media comprises two or more carriers, the apparatus further comprising:
a controlled biofilm zone comprising a first carrier of the two or more carriers; and
an uncontrolled biofilm zone comprising a second carrier of the two or more carriers,
wherein a biofilm growing on the second carrier is sheared by the first carrier within the uncontrolled zone.

13. A method for removing constituents from an influent, the method comprising:
receiving a water mixture as influent;
treating, by a biological processor, the influent to output a treated liquor;
separating a solids mixture from the treated liquor; and
controlling a biofilm mass, biofilm volume, biofilm density, biofilm thickness, or a solids residence time of a biofilm comprised in at least one media surface provided by a biofilm media to grow and remove one or more constituents contained in the influent,
wherein the controlling the biofilm mass, biofilm volume, biofilm density, biofilm thickness, or the solids residence time comprises at least one of a:
applying a physical treatment process;
applying a biological treatment process; or
applying a chemical treatment process.

14. The method in claim 13, wherein the biofilm media includes at least one of a ridge, a grid, a macro-pore inclusion, or a micro-pore inclusion on the at least one media surface or within the biofilm media.

15. The method in claim 13, wherein the biofilm media has two or more media surfaces, each media surface having a different biofilm mass, biofilm volume, biofilm density, biofilm thickness, or solids residence time.

16. The method in claim 13, wherein the biological processor comprises a bioreactor or a biofiltration system.

17. The method in claim 13, wherein the separating the solids mixture from the treated liquor comprises applying a membrane, a filter, a clarifier or a hydrocyclone to the liquor.

18. The method in claim 13, wherein the chemical treatment process comprises adding a chemical agent or a biological agent to a recycle stream,
wherein the chemical agent comprises a reactant, an oxidant, or a reductant,
wherein the biological agent comprises a phage, a vector or a virus, and
wherein the biofilm mass, biofilm volume, biofilm density, biofilm thickness, or solids residence time is controlled by the chemical agent or biological agent.

19. The method in claim 13, wherein the biological treatment process comprises adding a nutrient or a cofactor to a recycle stream,
wherein the nutrient comprises a trace element, nitrogen or phosphorous,
wherein the cofactor comprises an organic coenzyme or an inorganic metal, and
wherein the biofilm mass, biofilm volume, biofilm density, biofilm thickness, or solids residence time is controlled by the nutrient or cofactor.

20. The method in claim 13, wherein the physical treatment process comprises:
applying a shearing force to the biofilm media by a solid-liquid separator to control the biofilm mass, biofilm volume, biofilm density, biofilm thickness, or solids residence time;
scouring the biofilm media by a gas to control the biofilm mass, biofilm volume, biofilm density, biofilm thickness, or solids residence time; or
backwashing the biofilm media to control the biofilm mass, biofilm volume, biofilm density, biofilm thickness, or solids residence time.
